(19) United States
(12) Patent Application Publication
(10) Pub. No.: US 2024/0283627 A1
(43) Pub. Date: Aug. 22, 2024

(54) PERIODIC OR SEMI-PERIODIC OCCASIONS, REPETITIONS, TRANSPORT BLOCKS OVER MULTIPLE SLOTS ON FULL-DUPLEX AND HALF-DUPLEX TIME PERIODS

(71) Applicant: QUALCOMM Incorporated, San Diego, CA (US)

(72) Inventors: Qian ZHANG, Basking Ridge, NJ (US); Yan ZHOU, San Diego, CA (US); Muhammad Sayed Khairy ABDELGHAFFAR, San Jose, CA (US)

(21) Appl. No.: 18/544,031

(22) Filed: Dec. 18, 2023

Related U.S. Application Data
(60) Provisional application No. 63/485,877, filed on Feb. 17, 2023.

(51) Int. Cl. H04L 5/14; H04L 5/16; H04W 72/0446; H04W 72/0453; H04W 72/12; H04W 72/232

(52) U.S. Cl. CPC H04L 5/1469; H04L 5/16; H04W 72/0446; H04W 72/0453; H04W 72/12; H04W 72/232

(57) ABSTRACT

A UE receives an indication of one or more full-duplex time periods and one or more half-duplex time periods and receives at least one resource allocation for downlink reception or uplink transmission of at least one of an uplink channel, a downlink channel, a reference signal, or a TBoMS, the at least one resource allocation that includes resources across at least one full-duplex time period and at least one half-duplex time period. The UE adjusts processing for at least conflicting resources of the at least one resource allocation based on the at least one resource allocation for the at least one of the uplink channel, the downlink channel, the reference signal, or the TBoMS within the one or more full-duplex time periods or the one or more half-duplex time periods. Then, the UE transmits or receives communication after adjusting the processing for at least the conflicting resources.

### CROSS REFERENCE TO RELATED APPLICATION

This application claims the benefit of and priority to U.S. Provisional Application Ser. No. 63/485,877, entitled “Periodic or Semi-Periodic Occasions, Repetitions, Transport Blocks over Multiple Slots on Full-Duplex and Half-Duplex Time Periods” and filed on Feb. 17, 2023, which is expressly incorporated by reference herein in its entirety.

### TECHNICAL FIELD

The present disclosure relates generally to communication systems, and more particularly, to wireless communication that includes half-duplex and full-duplex time resources.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus receives an indication of one or more full-duplex time periods and one or more half-duplex time periods and receives at least one resource allocation for downlink reception or uplink transmission of at least one of an uplink channel, a downlink channel, a reference signal, or a transport block over multiple slots (TBoMS), the at least one resource allocation that includes resources across at least one full-duplex time period and at least one half-duplex time period. The apparatus adjusts processing for at least conflicting resources of the at least one resource allocation based on the at least one resource allocation for the at least one of the uplink channel, the downlink channel, the reference signal, or the TBoMS within the one or more full-duplex time periods or the one or more half-duplex time periods. Then, the apparatus transmits or receives communication after adjusting the processing for at least the conflicting resources.

In an aspect of the disclosure, a method, a computer-readable medium, and an apparatus are provided for wireless communication at a base station. The apparatus provides an indication of one or more full-duplex time periods and one or more half-duplex time periods and provides at least one resource allocation for a UE for downlink reception or uplink transmission of at least one of an uplink channel, a downlink channel, a reference signal, or a transport block over multiple slots (TBoMS), the at least one resource allocation that includes resources across at least one full-duplex time period and at least one half-duplex time period. The base station then transmits or receives communication adjusted for at least conflicting resources of the at least one resource allocation based on the at least one resource allocation for the at least one of the uplink channel, the downlink channel, the reference signal, or the TBoMS within the one or more full-duplex time periods or the one or more half-duplex time periods.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network, in accordance with various aspects of the present disclosure.

FIGS. 4A, 4B, 4C, and 4D illustrate various modes of full duplex communication.

FIG. 5 illustrates examples of in-band full-duplex (IBFD) and sub-band frequency divisional duplex resources, in accordance with various aspects of the present disclosure.

FIG. 6 is a diagram illustrating an example sub-band full-duplex (SBFD) operation, in accordance with various aspects of the present disclosure.

FIG. 7 is a resource diagram illustrating aspects of communication over SBFD resources and half-duplex resources, in accordance with various aspects of the present disclosure.

FIG. 8 is a resource diagram illustrating aspects of communication over SBFD resources and half-duplex resources, in accordance with various aspects of the present disclosure.

FIG. 9 is a resource diagram illustrating aspects of communication over SBFD resources and half-duplex resources, in accordance with various aspects of the present disclosure.

FIG. 10 is a resource diagram illustrating aspects of communication over SBFD resources and half-duplex resources, in accordance with various aspects of the present disclosure.

FIG. 11 is a resource diagram illustrating aspects of communication over SBFD resources and half-duplex resources, in accordance with various aspects of the present disclosure.

FIG. 12 is a resource diagram illustrating aspects of communication over SBFD resources and half-duplex resources, in accordance with various aspects of the present disclosure.

FIG. 13 is a resource diagram illustrating aspects of communication over SBFD resources and half-duplex resources, in accordance with various aspects of the present disclosure.

FIG. 14 is a resource diagram illustrating aspects of communication over SBFD resources and half-duplex resources, in accordance with various aspects of the present disclosure.

FIG. 15 is a resource diagram illustrating aspects of communication over SBFD resources and half-duplex resources, in accordance with various aspects of the present disclosure.

FIG. 16 is a resource diagram illustrating aspects of communication over SBFD resources and half-duplex resources, in accordance with various aspects of the present disclosure.

FIG. 17 is a resource diagram illustrating aspects of communication over SBFD resources and half-duplex resources, in accordance with various aspects of the present disclosure.

FIG. 18 is an example communication flow between a UE and a base station, in accordance with various aspects of the present disclosure.

FIG. 19 is a flowchart of a method of wireless communication, in accordance with various aspects of the present disclosure.

FIG. 20 is a flowchart of a method of wireless communication, in accordance with various aspects of the present disclosure.

FIG. 21 is a diagram illustrating an example of a hardware implementation for an example apparatus and/or UE, in accordance with various aspects of the present disclosure.

FIG. 22 is a diagram illustrating an example of a hardware implementation for an example network entity, in accordance with various aspects of the present disclosure.

### DETAILED DESCRIPTION

A UE receives an allocation of resources from a base station scheduling the UE with resources for uplink transmission and/or downlink reception. The UE then uses the allocated resources to transmit uplink communication to the base station or to receive downlink communication from the base station. The base station and/or the UE may support full-duplex communication in which the device simultaneously transmits and receives communication. Some time periods may be designated for full-duplex operation of the base station and/or the UE, and other time periods may be designated for half-duplex operation of the UE and the base station. As an example, one or more slots or symbols may be designated as sub-band full-duplex (SBFD) slots or symbols, and the base station may operate in a full-duplex mode in the SBFD slots or symbols. Resources allocations for the UE may fall within half-duplex time slots or symbols and/or SBFD slots or symbols. As an example, the resource allocation may be for periodic or semi-periodic resources. As another example, the resource allocation may be for repetitions, e.g., PUSCH or PDSCH repetitions. As another example, the resource allocation may be for transport block over multiple slots (TBoMS). Aspects presented herein enable the UE to adjust processing of the resource allocation to account for the half-duplex and full-duplex time periods. The aspects presented herein enable greater flexibility in scheduling resource allocations, as well as in providing for full-duplex time periods. The use of full-duplex time periods may help to reduce latency and improve system capacity, resource utilization, and spectrum efficiency. The aspects presented herein provide a flexible and robust resource adaptation for uplink and downlink communication that improves communication between a UE and a base station while allowing for full-duplex communication to be supported for at least one of the devices.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

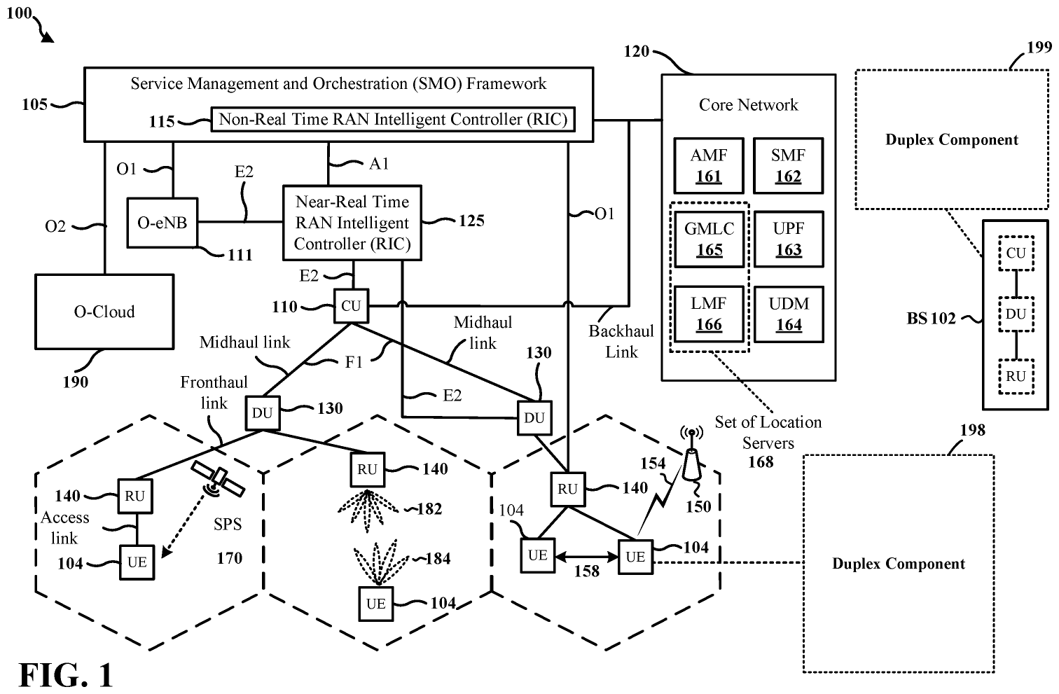

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FRI (410 MHZ-7.125 GHZ) and FR2 (24.25 GHz-52.6 GHZ). Although a portion of FR1 is greater than 6 GHZ, FRI is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FRI, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming.

The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a duplex component 198 that may be configured to receive an indication of one or more full-duplex time periods and one or more half-duplex time periods; receive at least one resource allocation for downlink reception or uplink transmission of at least one of an uplink channel, a downlink channel, a reference signal, or a transport block over multiple slots (TBoMS), the at least one resource allocation that includes resources across at least one full-duplex time period and at least one half-duplex time period; adjust processing for at least conflicting resources of the at least one resource allocation based on the at least one resource allocation for the at least one of the uplink channel, the downlink channel, the reference signal, or the TBoMS within the one or more full-duplex time periods or the one or more half-duplex time periods; and transmit or receive communication after adjusting the processing for at least the conflicting resources. In certain aspects, the base station 102 may have a duplex component 199 that may be configured to provide an indication of one or more full-duplex time periods and one or more half-duplex time periods; provide at least one resource allocation for a UE for downlink reception or uplink transmission of at least one of an uplink channel, a downlink channel, a reference signal, or a transport block over multiple slots (TBoMS), the at least one resource allocation that includes resources across at least one full-duplex time period and at least one half-duplex time period; and transmit or receive communication adjusted for at least conflicting resources of the at least one resource allocation based on the at least one resource allocation for the at least one of the uplink channel, the downlink channel, the reference signal, or the TBoMS within the one or more full-duplex time periods or the one or more half-duplex time periods.

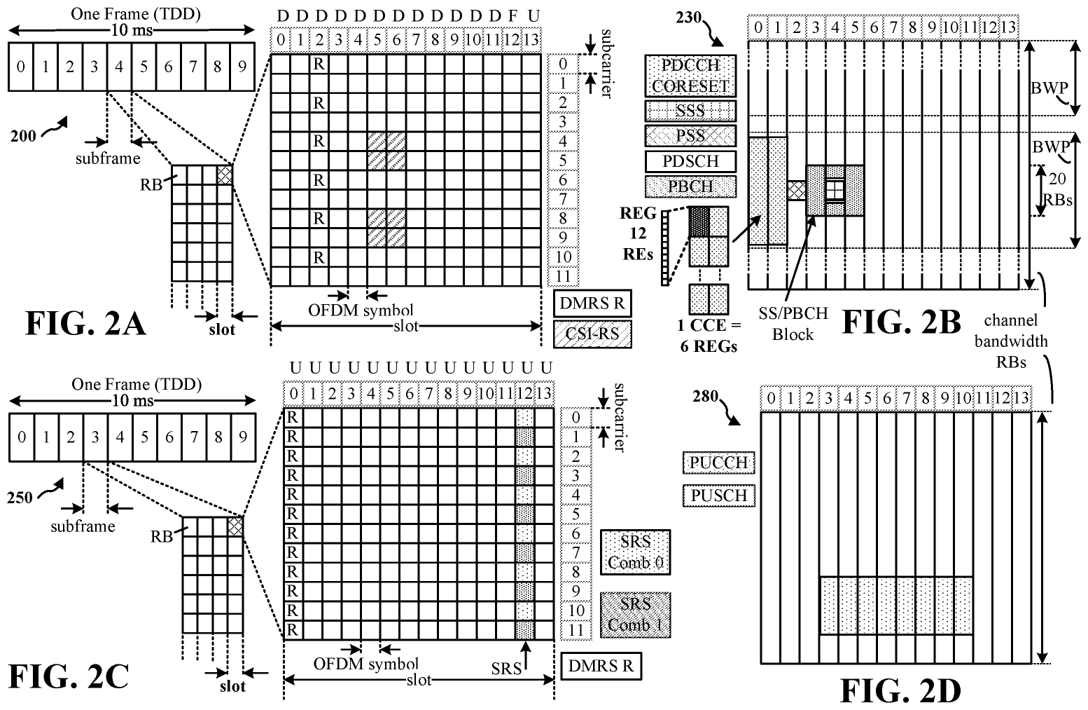

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2″ slots/subframe. The subcarrier spacing may be equal to 2″*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

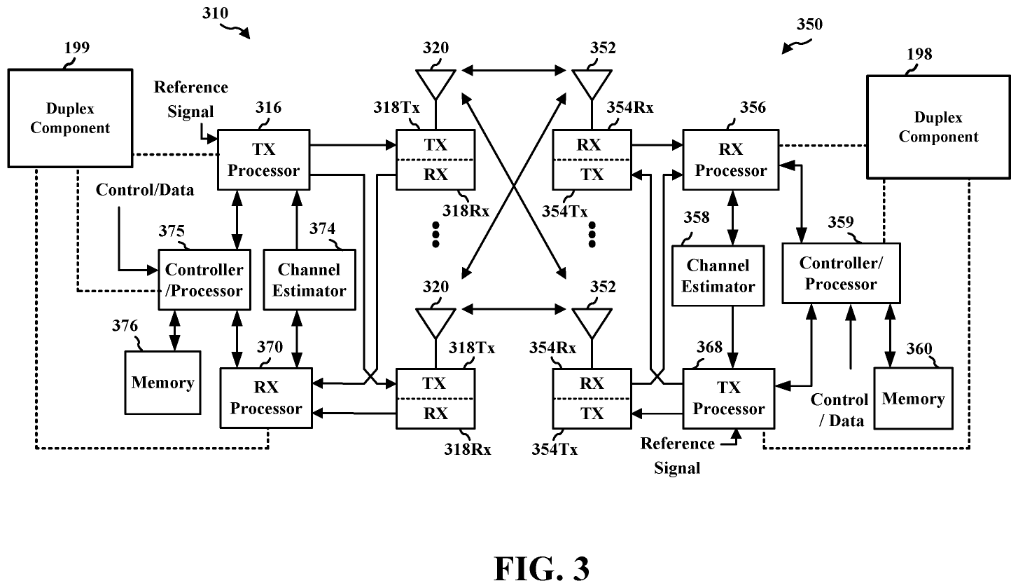

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the duplex component 198 of FIG. 1.

At least one of the TX processor 316, the RX processor 370, and the controller/processor 375 may be configured to perform aspects in connection with the duplex component 199 of FIG. 1.

Wireless communication systems may be configured to share available system resources and provide various telecommunication services (e.g., telephony, video, data, messaging, broadcasts, etc.) based on multiple-access technologies that support communication with multiple users. Full duplex operation, in which a wireless device exchanges uplink and downlink communication that overlaps in time, may enable more efficient use of the wireless spectrum. Full duplex operation may include simultaneous transmission and reception in the same frequency range. In some examples, the frequency range may be an mmW frequency range, e.g., frequency range 2 (FR2). In some examples, the frequency range may be a sub-6 GHz frequency range, e.g., frequency range 1 (FR1). Full duplex communication may reduce latency. For example, full duplex operation may enable a UE to receive a downlink signal in an uplink-only slot, which can reduce the latency for the downlink communication. Full duplex communication may improve spectrum efficiency, e.g., spectrum efficiency per cell or per UE. Full duplex communication may enable more efficient use of wireless resources.

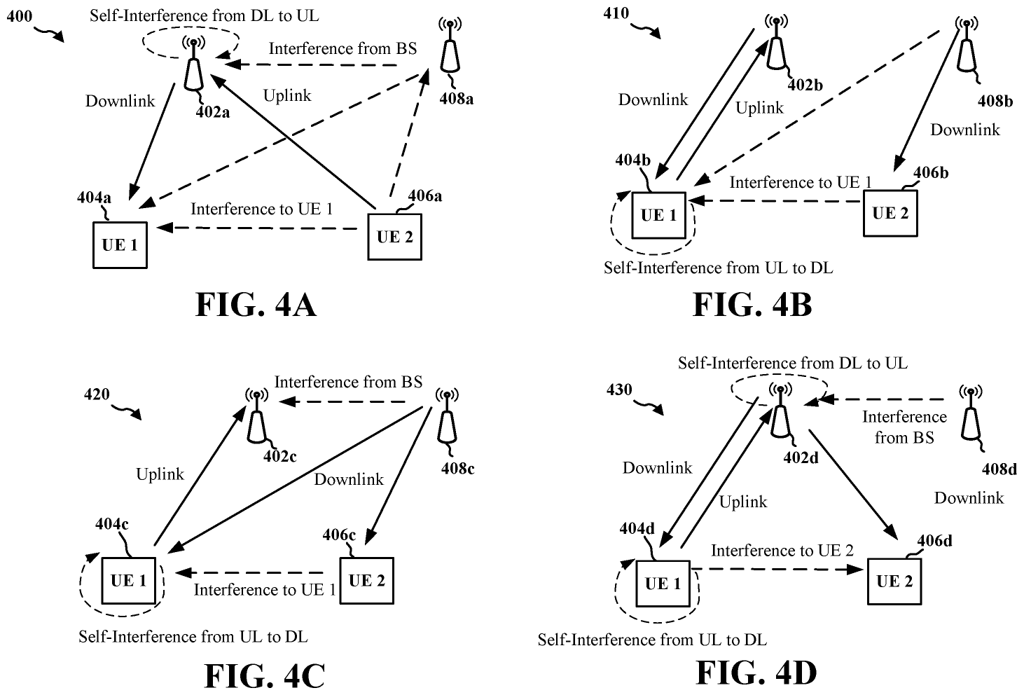

FIGS. 4A, 4B, 4C, and 4D illustrate various modes of full duplex communication. Full duplex communication supports the transmission and reception of information over the same frequency band in a manner that overlaps in time. In this manner, spectral efficiency may be improved with respect to the spectral efficiency of half-duplex communication, which supports the transmission or reception of information in one direction at a time without overlapping uplink and downlink communication. Due to the simultaneous Tx/Rx nature of full duplex communication, a UE or a base station may experience self-interference caused by signal leakage from its local transmitter to its local receiver. In addition, the UE or base station may also experience interference from other devices, such as transmissions from a second UE or a second base station. Such interference (e.g., self-interference or interference caused by other devices) may impact the quality of the communication or even lead to a loss of information.

FIG. 4A shows the first example of full duplex communication 400 in which a first base station 402a is in full duplex communication with a first UE 404a and a second UE 406a. The first UE 404a and the second UE 406a may be configured for half-duplex communication or full-duplex communication. FIG. 4A illustrates the first UE 404a performing downlink reception, and the second UE 406a performing uplink transmission. The second UE 406a may transmit a first uplink signal to the first base station 402a as well as to other base stations, such as a second base station 408a in proximity to the second UE 406a. The first base station 402a transmits a downlink signal to the first UE 404a concurrently (e.g., overlapping at least partially in time) with receiving the uplink signal from the second UE 406a. The base station 402a may experience self-interference at its receiving antenna that is receiving the uplink signal from UE 406a, the self-interference being due to reception of at least part of the downlink signal transmitted to the UE 404a. The base station 402a may experience additional interference due to signals from the second base station 408a. Interference may also occur at the first UE 404a based on signals from the second base station 408a as well as from uplink signals from the second UE 406a.

FIG. 4B shows the second example of full-duplex communication 410 in which a first base station 402b is in full-duplex communication with a first UE 404b. In this example, the UE 404b is also operating in a full-duplex mode. The first base station 402b and the UE 404b receive and transmit communication that overlaps in time and is in the same frequency band. The base station and the UE may each experience self-interference, due to a transmitted signal from the device leaking to (e.g., being received by) a receiver at the same device. The first UE 404b may experience additional interference based on one or more signals emitted from a second UE 406b and/or a second base station 408b in proximity to the first UE 404b.

FIG. 4C shows the third example of full-duplex communication 420 in which a first UE 404c transmits and receives full-duplex communication with a first base station 402c and a second base station 408c. The first base station 402c and the second base station 408c may serve as multiple transmission and reception points (multi-TRPs) for UL and DL communication with the UE 404c. The second base station 408c may also exchange communication with a second UE 406c. In FIG. 4C, the first UE 404c may transmit an uplink signal to the first base station 402c that overlaps in time with receiving a downlink signal from the second base station 408c. The first UE 404c may experience self-interference as a result of receiving at least a portion of the first signal when receiving the second signal, e.g., the UE's uplink signal to the base station 402c may leak to (e.g., be received by) the UE's receiver when the UE is attempting to receive the signal from the other base station 408c. The first UE 404c may experience additional interference from the second UE 406c.

FIG. 4D shows the fourth example of full-duplex communication 430 in which a first base station 402d employs full-duplex communication with a first UE 404d, and transmits downlink communication to a second UE 406d. In this example, the first UE 404d is operating in a full-duplex mode, and the second UE 406d is operating in a half-duplex mode. The first base station 402d and the first UE 404d receive and transmit communication that overlaps in time and is in the same frequency band. The base station 402d and the first UE 404d may each experience self-interference, due to a transmitted signal from the corresponding device leaking to (e.g., being received by) a receiver at the same device. The base station 402d may further experience cross link interference due to a signal transmitted by the base station 408d. The second UE 406d may experience cross-link interference from the uplink transmission of the first UE 404b when receiving downlink communication from the base station 402d.

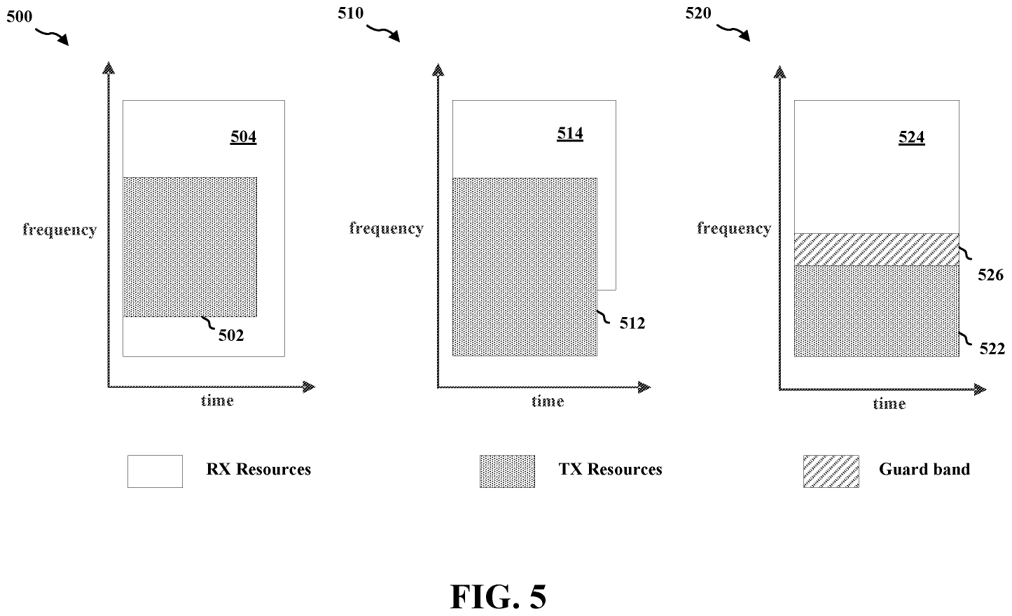

Full duplex communication may be in the same frequency band. The uplink and downlink communication may be in different frequency sub-bands, in the same frequency sub-band, or in partially overlapping frequency sub-bands. FIG. 5 illustrates a first example 500 and a second example 510 of in-band full-duplex (IBFD) resources and a third example 520 of SBFD resources. In IBFD, signals may be transmitted and received in overlapping times and overlapping in frequency. As shown in the first example 500, a time and a frequency allocation of transmission resources 502 may fully overlap with a time and a frequency allocation of reception resources 504. In the second example 510, a time and a frequency allocation of transmission resources 512 may partially overlap with a time and a frequency of allocation of reception resources 514.

IBFD is in contrast to sub-band FDD, where transmission and reception resources may overlap in time using different frequencies, as shown in the third example 520. In the third example 520, the UL, the transmission resources 522 are separated from the reception resources 524 by a guard band 526. The guard band may be frequency resources, or a gap in frequency resources, provided between the transmission resources 522 and the reception resources 524. Separating the transmission frequency resources and the reception frequency resources with a guard band may help to reduce self-interference. Transmission resources and reception resources that are immediately adjacent to each other may be considered as having a guard band width of 0. As an output signal from a wireless device may extend outside the transmission resources, the guard band may reduce interference experienced by the wireless device. Sub-band FDD may also be referred to as “flexible duplex”.

If the full-duplex operation is for a UE or a device implementing UE functionality, the transmission resources 502, 512, and 522 may correspond to uplink resources, and the reception resources 504, 514, and 524 may correspond to downlink resources. Alternatively, if the full-duplex operation is for a base station or a device implementing base station functionality, the transmission resources 502, 512, and 522 may correspond to downlink resources, and the reception resources 504, 514, and 524 may correspond to uplink resources.

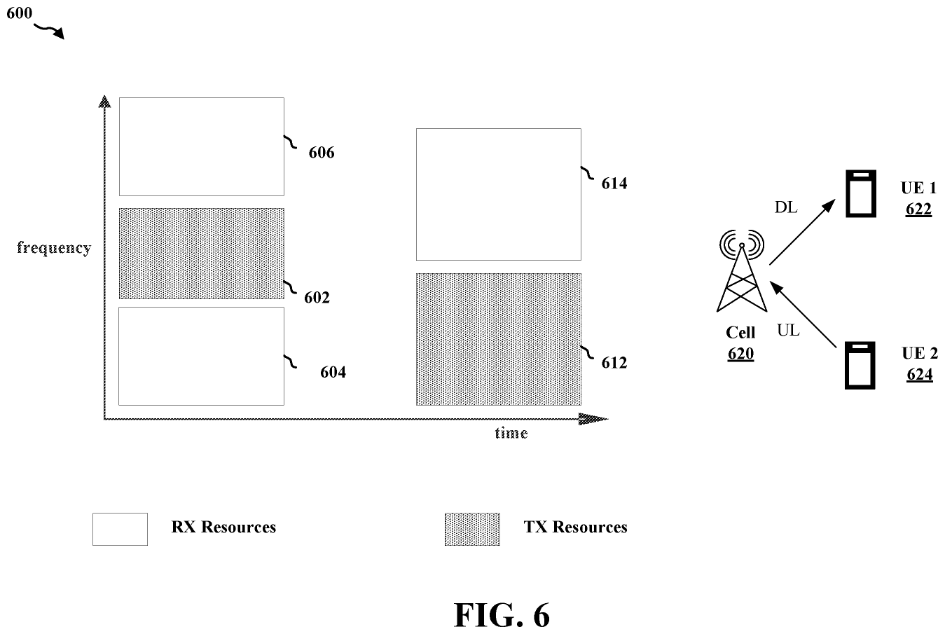

SBFD supports simultaneous Tx/Rx of DL/UL on a sub-band basis. SBFD may increase the UL duty cycle, leading to latency reduction and improvement in UL coverage. For example, under SBFD, a UL signal may be transmitted in DL slots or flexible slots, and a DL signal may be received in UL slots, leading to latency savings. SBFD may enhance the system capacity, resource utilization, spectrum efficiency, and enable flexible and dynamic UL/DL resource adaption according to UL/DL traffic in a robust manner. FIG. 6 is a diagram 600 illustrating an example SBFD operation. As shown in FIG. 6, a cell 620 may have DL communication with one UE (e.g., UE 1 622), and simultaneously have UL communication with another UE (e.g., UE 2 624) on the same slot. In one example, the DL communication with UE 1 622 may utilize RX resources 604, 606, and the UL communication with UE 2 624 may utilize TX resources 602. In another example, the DL communication with UE 1 622 may utilize RX resources 614, and the UL communication with UE 2 624 may utilize TX resources 612.

A UE receives an allocation of resources from a base station scheduling the UE with resources for uplink transmission and/or downlink reception. The UE then uses the allocated resources to transmit uplink communication to the base station or to receive downlink communication from the base station. As described in connection with FIGS. 4A-6, base station and/or the UE may support full-duplex communication in which the device simultaneously transmits and receives communication. Some time periods may be designated for full-duplex operation of the base station and/or the UE, and other time periods may be designated for half-duplex operation of the UE and the base station. As an example, one or more slots or symbols may be designated as SBFD slots or symbols, and the base station may operate in a full-duplex mode in the SBFD slots or symbols. Resources allocations for the UE may fall within half-duplex time slots or symbols and/or SBFD slots or symbols.

As an example, the resource allocation may be for periodic or semi-periodic resources. As an example, a UE may receive a configured grant in RRC signaling that provides periodic or semi-persistent resources for the UE to use for uplink transmission such as for PUCCH or PUSCH. The UE may receive an RRC configuration for semi-persistent scheduling (SPS) resources for the periodic or semi-persistent reception of downlink communication, such as PDCCH or PDSCH. In some aspects, the UE may use the configured grant or SPS resources based on the RRC configuration without further activation or signaling. In other aspects, the UE may receive additional control signaling, such as in a MAC-CE or DCI, that activates or enables a previously received configured grant or SPS. The scheduled or configured resources may be for PUCCH, PUSCH, PDCCH, and/or PDSCH without repetition and may fall within SBFD symbols or slots and in non-SBFD (e.g., half-duplex) symbols or slots.

As another example, the resource allocation may be for the UE to transmit SRS or receive and measure a CSI-RS. The resources allocated for the reference signals may fall within SBFD symbols or slots and in non-SBFD (e.g., half-duplex) symbols or slots.

As another example, the resource allocation may be for transport block over multiple slots (TBoMS). As the TBoMS spans multiple slots, the resources allocated for the TBoMS may fall within SBFD symbols or slots and in non-SBFD (e.g., half-duplex) symbols or slots.

In some aspects, the resource allocation may correspond to multiple PUSCH transmissions scheduled by a single DCI or multiple PDSCH transmissions scheduled by a single DCI. The resources allocated for the different transmissions may fall within SBFD symbols or slots and in non-SBFD (e.g., half-duplex) symbols or slots.

In some aspects, the resource allocation may correspond to PDSCH, PUSCH, or PUCCH with repetition across SBFD symbols or slots and in non-SBFD (e.g., half-duplex) symbols or slots.

In some aspects, the resource allocation may include intra-slot frequency hopping, inter-slot frequency hopping, inter-repetition frequency hopping, and/or inter-group frequency hopping with demodulation reference signal (DMRS) bundling for PUSCH or PDSCH.

The resource allocation may include any combination of a frequency domain resource allocation (FDRA), a frequency hopping allocation, a time domain resource allocation (TDRA), a power domain resource allocation, and/or a spatial domain resource allocation.

Aspects presented herein enable the UE to adjust processing of the resource allocation to account for the half-duplex and full-duplex time periods. The aspects presented herein enable greater flexibility in scheduling resource allocations, as well as in providing for full-duplex time periods. The use of full-duplex time periods may help to reduce latency and improve system capacity, resource utilization, and spectrum efficiency. The aspects presented herein provide a flexible and robust resource adaptation for uplink and downlink communication that improves communication between a UE and a base station while allowing for full-duplex communication to be supported for at least one of the devices. In some aspects, PUCCH, PUSCH, PDSCH, and/or PDCCH may be mapped to SBFD and non-SBFD symbols within a same slot. Aspects presented herein provide a solution for single occasions of uplink or downlink communication across SBFD slots or symbols.

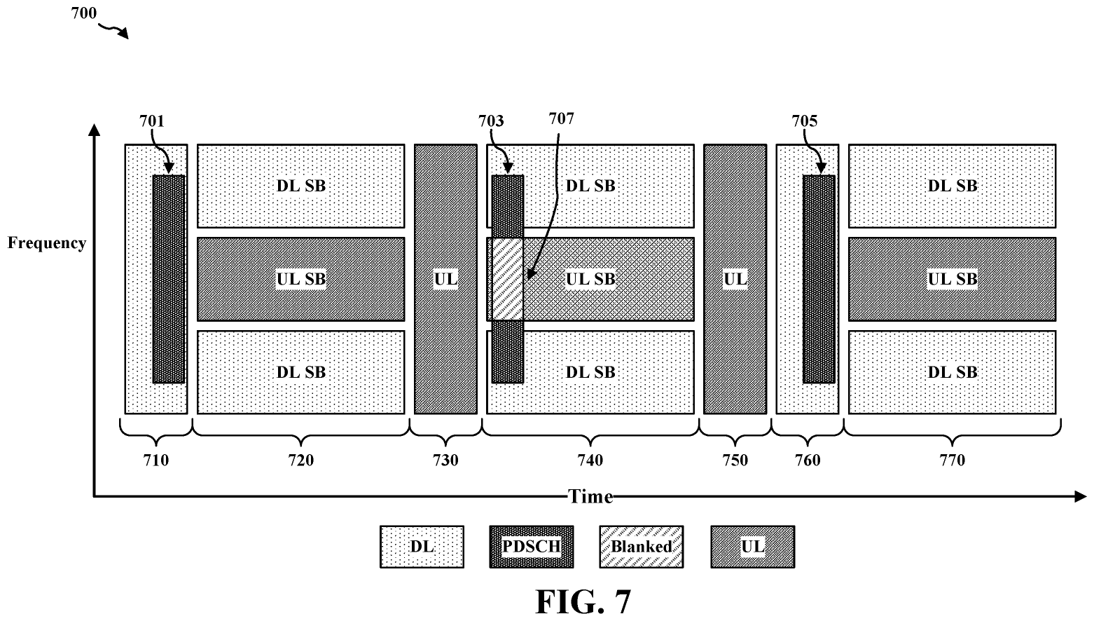

FIG. 7 illustrates an example resource diagram 700 showing time periods 710 and 760 that may be designated, e.g., by the network, for downlink half-duplex communication. The time periods 730 and 750 may be designated by the network for uplink half-duplex communication. The time periods 710, 730, 750, and 760 may each correspond to one or more slots or one or more symbols, and may each have different lengths in time. FIG. 7 also shows time periods 720, 740, and 770, which may be designated by the network for full-duplex communication, e.g., SBFD. The time periods 720, 740, and 760 are shown as having two downlink frequency sub-bands and an uplink sub-band. The full-duplex time periods may include any configuration of uplink and downlink frequency resources, e.g., including any of the aspects described in connection with FIG. 5 or FIG. 6. The time periods may include one or more uplink sub-bands and one or more downlink sub-bands. FIG. 7 illustrates that allocated resources for PDSCH, as one example, may overlap in time with, or fall within, half-duplex time periods (e.g., as shown for PDSCH transmissions 701 and 705) as well as full-duplex time periods, as shown for the PDSCH transmission 703. PDSCH is only one example, and the resource allocation may include PDCCH, PDSCH, PUSCH, PUCCH, or one or more reference signals such as SRS, or CSI-RS. The resource allocation may be for periodic, aperiodic, or semi-persistent transmission/occasions. The resource allocation may be for repetitions or transmissions without repetitions. The resource allocation may correspond to a TBoMS. FIG. 7 illustrates an example in which the FDRA, e.g., the span of frequency resources, and the TDRA, e.g., the span of time resources, may be consistent across the different occasions. For example, the resources may be allocated with a single FDRA and/or TDRA across the different transmission occasions. For each occasion that falls at full on SBFD slots or symbols, the RBs on the reverse direction to the allocation may be rate matched around. As an example, the portion 707 of the PUSCH transmission occasion, e.g., 703 that falls in the uplink sub-band may be rate matched around for the PDSCH transmission. In some aspects, the guard band between the uplink sub-band and the downlink sub-bands may also be included in the RBs around which the PDSCH will be rate matched. The PDSCH transmissions 701 and 705 that do not overlap with SBFD symbols can be transmitted without rate matching, e.g., without dropping RBs from the allocated resources.

Although this example is described for PDSCH, the example may similarly be applied for PDCCH or CSI-RS. As well, the concept may be similarly applied for PUSCH, PUCCH, or SRS that overlaps with downlink resources of a SBFD time period.

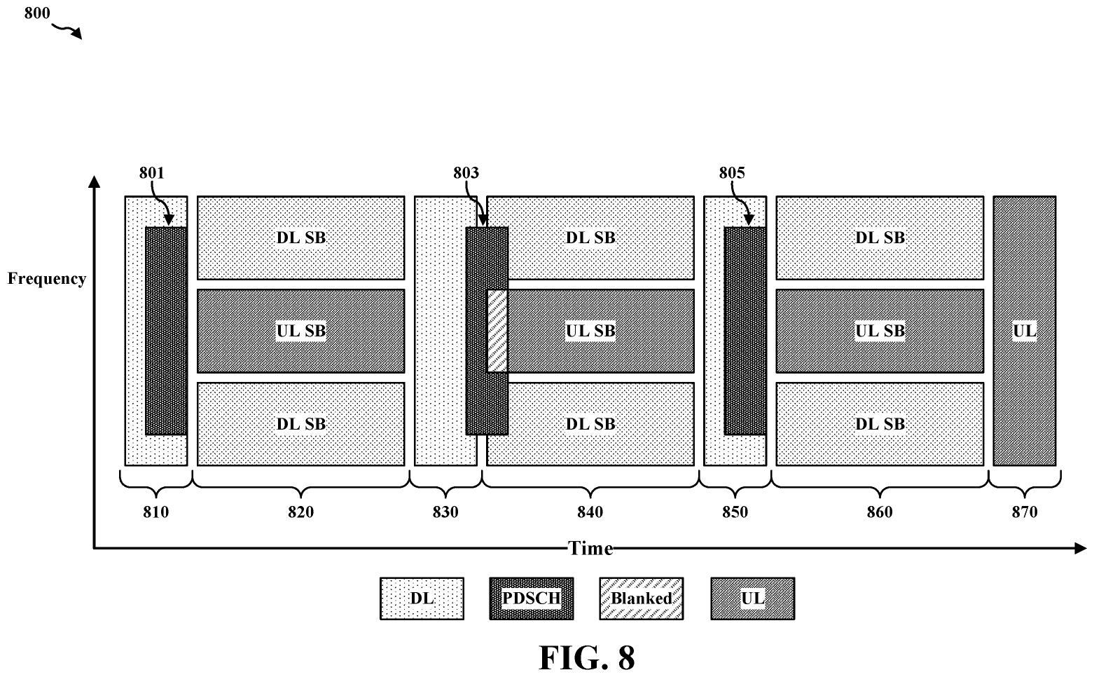

FIG. 8 illustrates an example resource diagram 800 similar to FIG. 7 and including downlink half-duplex time periods 810, 830, and 850; uplink half-duplex time periods 870; and SBFD time periods 820, 840, and 860. As with FIG. 7, each of the time periods may span one or more symbols or one or more slots. FIG. 8 includes PDSCH occasions 801 and 805 that are located within the downlink half-duplex time periods. The resource allocation may be for periodic, aperiodic, or semi-persistent transmission/occasions. The resource allocation may be for repetitions or transmissions without repetitions. The resource allocation may correspond to a TBoMS. The resource allocation for the PDSCH transmission 803 overlaps within a SBFD time period 840, similar to 703 in FIG. 7. However, in contrast to FIG. 7, the PDSCH transmission 803 also overlaps in time with a half-duplex time period 830 and may further overlap in time with a time gap between the half-duplex time period 830 and the SBFD time period 840. As described in connection with FIG. 7, the RBs in the uplink sub-band (e.g., which may be referred to as a reverse direction for the PDSCH or conflicting resources with the PDSCH resource allocation) may be dropped, or rate matched around when generating the PDSCH at 803. The PDSCH at 803 may also rate match around the guard bands, e.g., in frequency, between the uplink sub-band and the downlink sub-bands. As shown in FIG. 8, the rate matching may be performed around the conflicting resources, e.g., RBs, for the particular PDSCH transmission occasion. In some aspects, the rate matching may further be performed for the time gap between the half-duplex time resource, e.g., 830, and the SBFD time resource, e.g., 840. Although this example is described for PDSCH, the example may similarly be applied for PDCCH or CSI-RS. As well, the concept may be similarly applied for PUSCH, PUCCH, or SRS that overlaps with downlink resources of a SBFD time period.

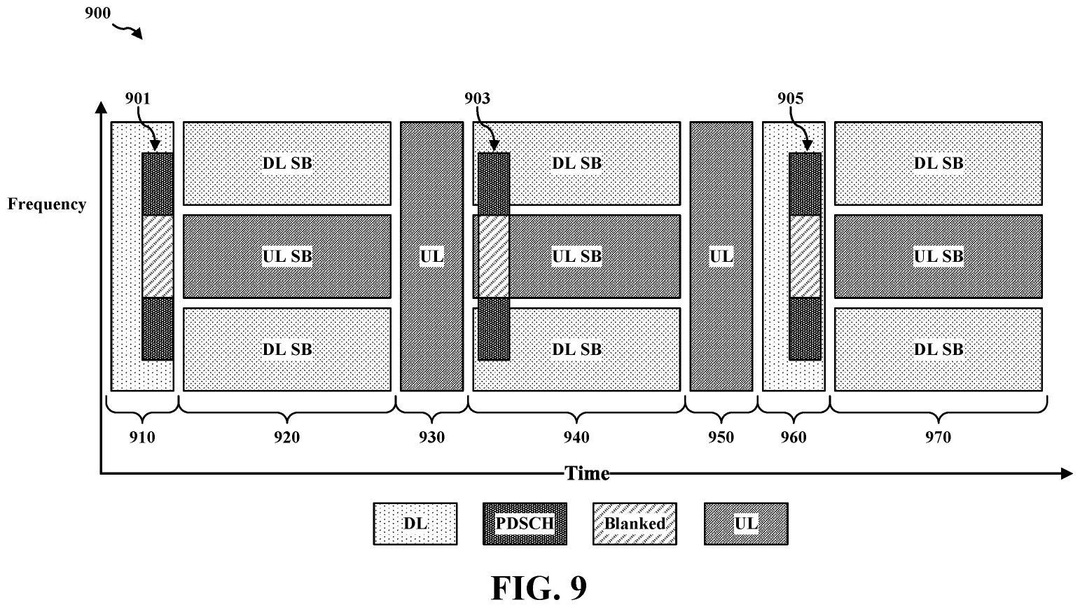

FIG. 9 illustrates an example resource diagram 900 similar to FIG. 7 and FIG. 8, which includes downlink half-duplex time periods 910 and 960; uplink half-duplex time resources 930 and 950; and SBFD time resources 920 and 970. As with FIG. 7, each of the time periods may span one or more symbols or one or more slots. FIG. 9 includes PDSCH occasions 901 and 905 that are located within the downlink half-duplex time periods. The resource allocation may be for periodic, aperiodic, or semi-persistent transmission/occasions. The resource allocation may be for repetitions or transmissions without repetitions. The resource allocation may correspond to a TBoMS. The resource allocation for the PDSCH transmission 903 overlaps within a SBFD time period 940, similar to 703 in FIG. 7. Each of the PDSCH may have a shared FDRA, a single FDRA, or the same FDRA across the different transmission occasions. In the example in FIG. 8, the PDSCH may be rate matched around the RBs for the reverse direction (e.g., uplink sub-band as the reverse direction to PDSCH). For example, the PDSCH transmission 903 drops or does not include the RBs that are within the uplink sub-band (and may further not include the guard band resources and/or time gap resources), similar to the PDSCH transmission 703 in FIG. 7. In contrast to FIG. 7, in FIG. 9, the PDSCH transmissions within the half-duplex slots or symbols may also be rate matched around the RBs that would fall within reverse direction sub-band(s) in the full-duplex time period, e.g., 940. In this example, the rate matching may be performed around the RBs of the reverse direction (e.g., which may also be referred to as conflicting resources or opposite direction resources) of a SBFD time period, regardless of whether the particular transmission occasion falls within the SBFD time period or a half-duplex time period. In some aspects, the example in FIG. 9 may be referred to as occasion common adaption or occasion common rate matching, e.g., an adaption or rate matching that is applied in common between each of the transmission occasions whether or not they overlap with the SBFD slots or symbols. The examples in FIGS. 7 and 8 may be referred to as occasion specific adaptation, because the adaptation or rate matching may be applied for individual transmission occasions depending on whether or not they overlap with SBFD time periods. The common rate matching may provide the same set of modulated symbols, and the RBs for one repetition may be reused for additional repetitions that may or may not fall within a SBFD time period. The common rate matching example in FIG. 9 may allow for reduced complexity at the UE, for example. Although this example is described for PDSCH, the example may similarly be applied for PDCCH or CSI-RS. As well, the concept may be similarly applied for PUSCH, PUCCH, or SRS that overlaps with downlink resources of a SBFD time period.

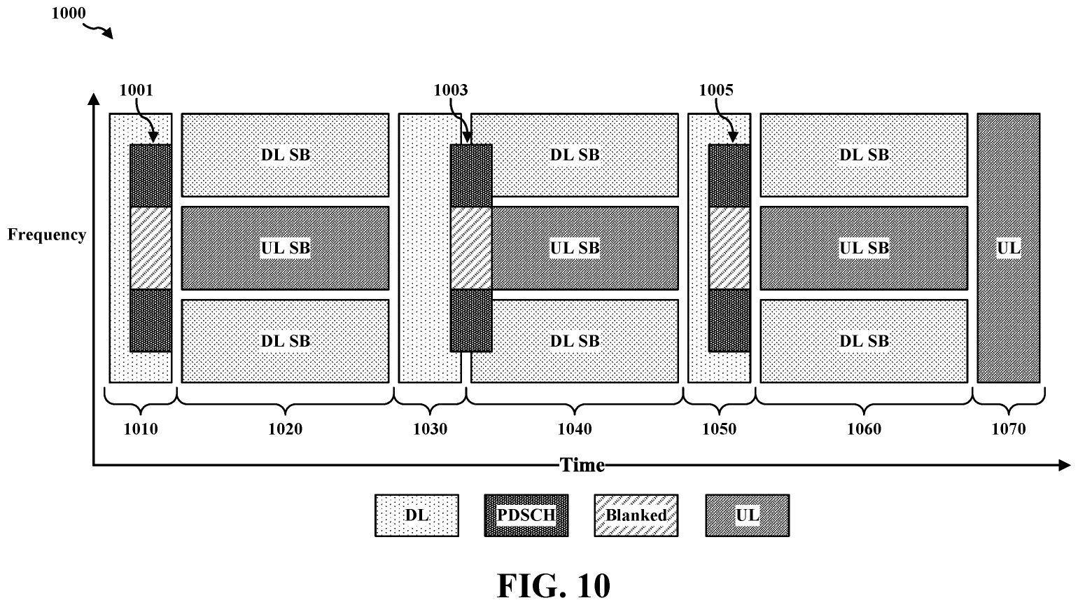

FIG. 10 illustrates an example resource diagram 1000 similar to FIG. 9, which includes downlink half-duplex time periods 1010 and 1030, and 1050; uplink half-duplex time resources 1070; and SBFD time resources 1020 and 1060. As with FIG. 9, each of the time periods may span one or more symbols or one or more slots. FIG. 10 includes PDSCH occasions 1001 and 1005 that are located within the downlink half-duplex time periods. The resource allocation may be for periodic, aperiodic, or semi-persistent transmission/occasions. The resource allocation may be for repetitions or transmissions without repetitions. The resource allocation may correspond to a TBoMS. The resource allocation for the PDSCH transmission 1003 overlaps partially with a SBFD time period 1040, similar to 903 in FIG. 9, and also overlaps with the half-duplex time period 1030, similar to FIG. 8. In FIG. 10, the rate matching may be further performed around the time resources of the time gap between the half-duplex time period 1030 and the SBFD time period 1040. Although this example is described for PDSCH, the example may similarly be applied for PDCCH or CSI-RS. As well, the concept may be similarly applied for PUSCH, PUCCH, or SRS that overlaps with downlink resources of a SBFD time period.

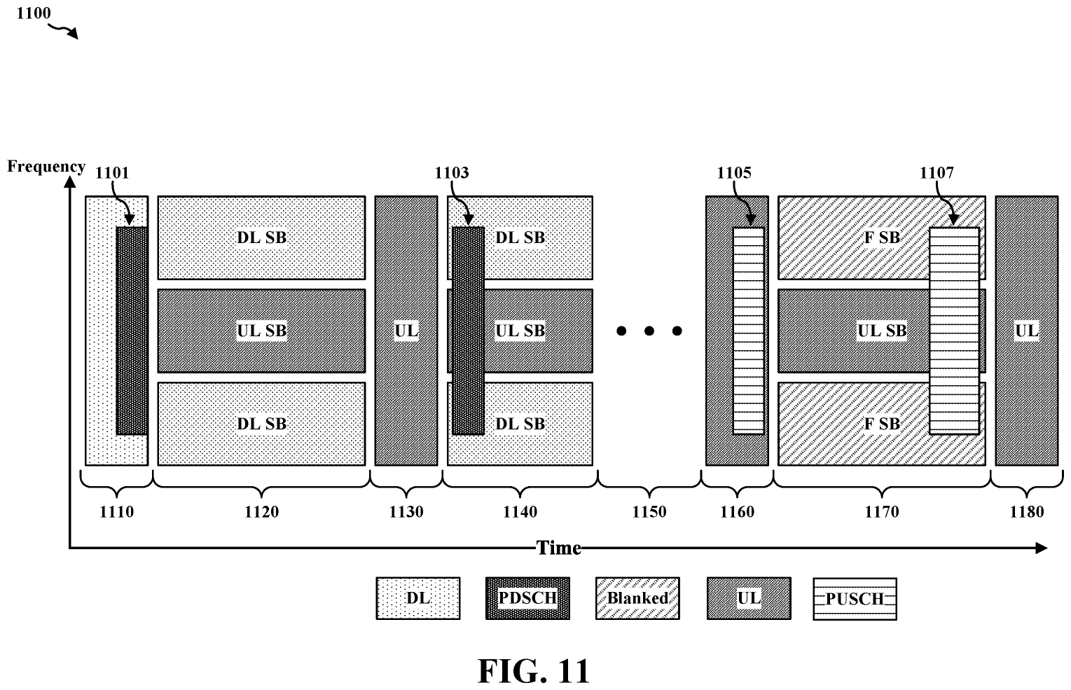

FIG. 11 illustrates an example time resource diagram 1100 having downlink half-duplex time period 1110; uplink half-duplex time resources 1130, 1160, and 1180; and SBFD time periods 1120, 1140, and 1170. The time location 1150 illustrates that the illustrated examples may be separated by any length of time or may occur separately. In the example illustrated in FIG. 11, the PDSCH transmissions 1101 and 1103 may be based on a single FDRA across each of the transmission occasions, and similarly, the PUSCH transmissions 1105 and 1107 may be based on a single FDRA across each of the transmission occasions. The resource allocation may be for periodic, aperiodic, or semi-persistent transmission/occasions. The resource allocation may be for repetitions or transmissions without repetitions. The resource allocation may correspond to a TBoMS. FIG. 11 illustrates that the conflicting RBs of a reverse direction in a SBFD time period (e.g., the uplink resources in the SBFD time period 1140) may still be used for the PUSCH transmission 1107. Similarly, the conflicting RBs that are outside of the uplink sub-band in the SBFD time period 1170 may be used for the PUSCH transmission 1107. As an example, in some aspects, the conflicting uplink RB may be indicated to fall-back, update, or revert to downlink resources based on one or more conditions. As an example of a condition, the fall-back may be performed if the SBFD time period is configured on a D symbol or on a flexible (F) symbol, e.g., of a time division duplex (TDD) uplink downlink slot pattern or symbol pattern, as shown for the PDSCH 1103. As another example of a condition, the fall-back may be performed if the SBFD time period occurs during, or overlaps with, a F symbol, e.g., of a TDD uplink downlink symbol pattern, e.g., as illustrated for the PUSCH 1107. If common occasion adaptation is applied, e.g., as described in connection with FIGS. 9 and 10, the RBs outside the UL sub-band can be considered as flexible sub-bands essentially, e.g. so that an uplink transmission can occur in a flexible F sub-band (e.g., with an indication from the UE and/or the base station). In some aspects, the fall-back to use the conflicting resources of the SBFD sub-band for the transmission may be based on an indication or configuration from the base station to the UE. In some aspects, the fall-back may be performed based on an application of a defined rule. Although this example is described for PDSCH and PUSCH, the concept may be similarly applied for PUCCH or PDCCH that overlaps with a SBFD time period.

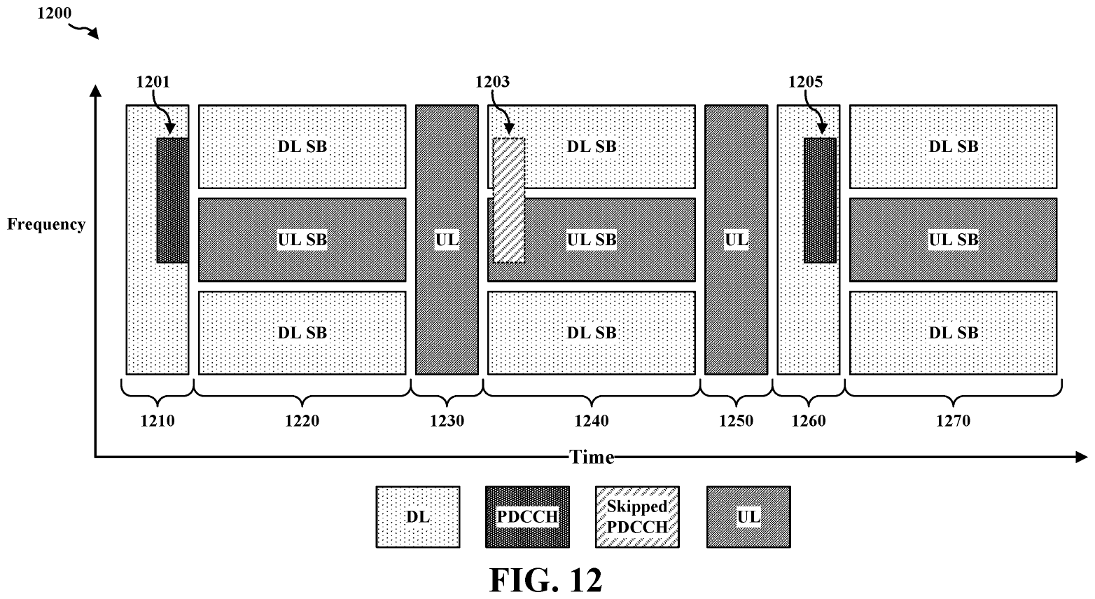

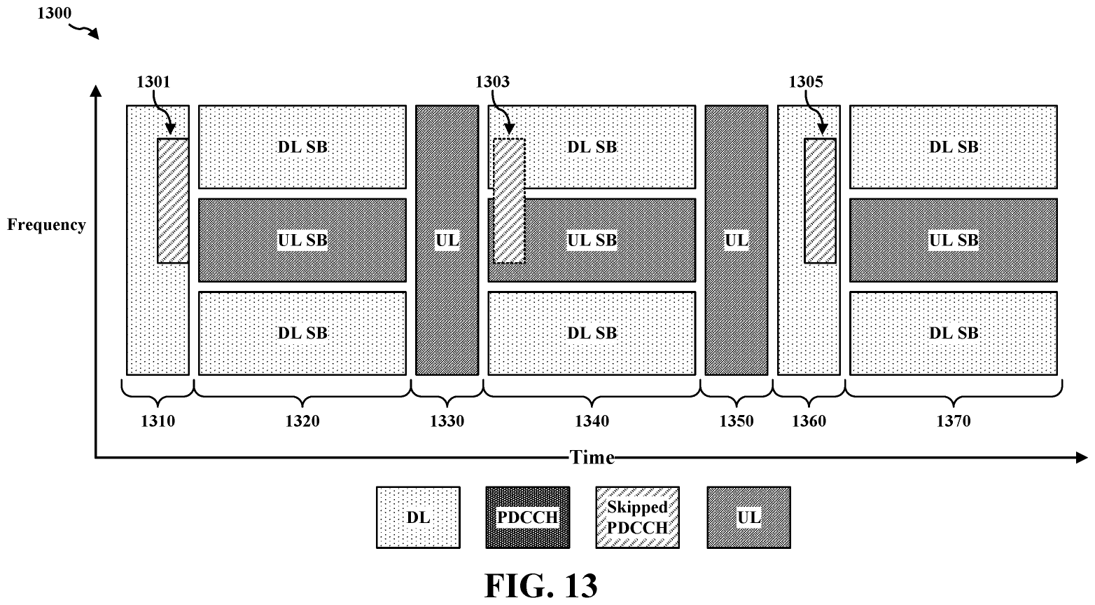

FIG. 12 illustrates an example time resource diagram 1200 having downlink half-duplex time periods 1210 and 1260; uplink half-duplex time period 1230 and 1250; and SBFD time periods 1220, 1240, and 1270. In the example illustrated in FIG. 12, the PDCCH transmissions 1201, 1203, and 1205 may be based on a single (or common) FDRA across each of the transmission occasions. The resource allocation may be for periodic, aperiodic, or semi-persistent transmission/occasions. The resource allocation may be for repetitions or transmissions without repetitions. The resource allocation may correspond to a TBoMS. FIG. 12 illustrates that PDCCH transmission 1203 may be dropped or skipped in a SBFD time resource, e.g., in which the PDCCH transmission overlaps with conflicting, reverse direction resources (e.g., the uplink sub-band of the SBFD time period 1240). For example, the base station may drop any PDCCH occasion in SBFD time periods, e.g., 1203, such as if a PDCCH transmission occasion occurs in the uplink time period, e.g., 1250, or in non-SBFD symbols (e.g., as shown in FIG. 13). In some aspects, one or more of the conditions may be RRC configured or may be a defined rule. The dropping, or skipping of PDCCH transmission occasions that overlap with conflicting resources in a full-duplex time period may allow for reduced complexity at the transmitter and receiver, e.g., without dynamic rate (e.g., variable or different) matching for the same set of occasions. As an example, the PDCCH transmissions 1201, 1203, and 1205 may be for a same SPS configuration. Although the example in FIG. 12 is illustrated for PDCCH, the aspects may be similarly applied for PUCCH, PUSCH, or PDSCH that overlaps with conflicting resources of a reverse direction in an SBFD time period. In some aspects, no PDCCH occasion may be provided for SS monitoring on SBFD symbols, e.g., to protect the PDCCH from cross-link interference. In some aspects, if a PDCCH occasion falls within the SBFD time period, the base station may skip transmission of the PDCCH, and the UE may skip monitoring for the PDCCH. In some aspects, the loss of periodicity for the PDCCH occasions may be addressed by the base station, e.g., by configuring multiple configuration IDs for PDCCH. The multiple configuration IDs may include 2 configuration IDs for PDCCH, for example.

Although this example is described for PDCCH, the example may similarly be applied for PDSCH or CSI-RS. As well, the concept may be similarly applied for PUSCH, PUCCH, or SRS that overlaps with downlink resources of a SBFD time period.

In some aspects, different resource allocations may be provided for application in SBFD time periods and non-SBFD time periods (e.g., half-duplex time periods).

FIG. 13 illustrates an example time resource diagram 1300 having downlink half-duplex time periods 1310 and 1360; uplink half-duplex time resources 1330 and 1350; and SBFD time resources 1320, 1340, and 1370. In the example illustrated in FIG. 13, the PDCCH transmissions 1301, 1303, and 1305 may be based on a single (or common) FDRA across each of the transmission occasions. The resource allocation may be for periodic, aperiodic, or semi-persistent transmission/occasions. The resource allocation may be for repetitions or transmissions without repetitions. The resource allocation may correspond to a TBoMS. As described in connection with FIG. 12, in some aspects, the PDCCH occasions may also be dropped in the non-SBFD slots or symbols, e.g., such as at the downlink time periods 1310 and 1360, based on the overlap of one of the transmission occasions, e.g., 1303, with the SBFD time period. Although this example is described for PDCCH, the example may similarly be applied for PDSCH or CSI-RS. As well, the concept may be similarly applied for PUSCH, PUCCH, or SRS that overlaps with downlink resources of a SBFD time period.

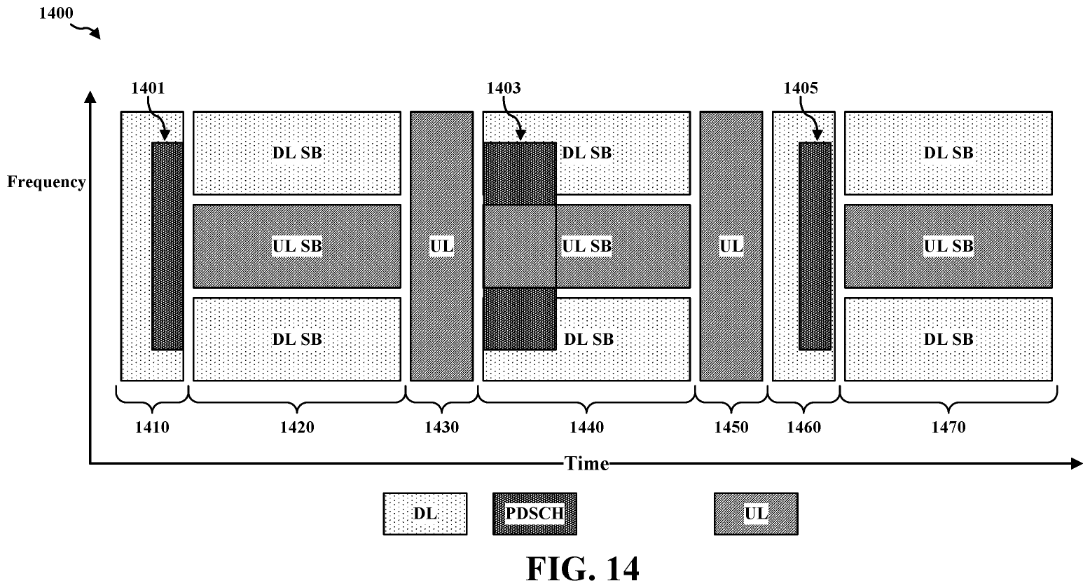

FIG. 14 illustrates an example time resource diagram 1400 having downlink half-duplex time periods 1410, and 1460; uplink half-duplex time resources 1430 and 1450; and SBFD time resources 1420, 1440, and 1470. In the example illustrated in FIG. 14, the PDSCH transmissions 1401 and 1405 may be based on a different resource allocation (e.g., a different FDRA and/or TDRA) than the PDSCH transmission 1403 based on being in different types of time periods (e.g., half-duplex in comparison to the full-duplex time period in which the PDSCH transmission occasion for 1403 occurs). This allows for different resource allocations for SBFD and non-SBFD symbols or slots, for example. The resource allocation may be for periodic, aperiodic, or semi-persistent transmission/occasions. The resource allocation may be for repetitions or transmissions without repetitions. The resource allocation may correspond to a TBoMS.

As an example, a base station may configure two TDRAs and/or two FDRAs with a single configuration identifier (ID). One TDRA/FDRA is applicable for half-duplex time periods, and the other TDRA/FDRA is applicable for full-duplex time periods. In some aspects, the base station may provide different frequency allocations for the SBFD and non-SBFD time periods, e.g., in order to avoid allocating resources that conflict with one or more sub-bands of a SBFD slot or symbol. In some aspects, the two allocations may have different TDRAs, e.g., different numbers of symbols for SBFD symbols/slots and half-duplex symbols/slots, e.g. 2 symbols for non-SBFD symbols/slots and 4 symbols for SBFD symbols/slots. FIG. 14 illustrates the PDSCH transmission occasion 1403 having a different FDRA (e.g., not allocating RBs in the uplink sub-band) and TDRA (e.g., having a longer duration) than the PDSCH transmission occasions 1401 and 1405. The different resource allocations that can be applied depending on the type of time period in which it occurs (e.g., SBFD symbol/slot or half-duplex symbol/slot). The UE may implicitly know and apply the different resource allocations to the different time occasions, e.g., applying FDRA/TDRA1 for the configuration ID in half-duplex slots or symbols and FDRA/TDRA2 in SBFD slots or symbols. In some aspects, the UE may interpret or apply the two configurations for the single configuration ID based on a rule or a configuration or other indication from the base station. Although this example is described for PDSCH, the example may similarly be applied for PDCCH or CSI-RS. As well, the concept may be similarly applied for PUSCH, PUCCH, or SRS that overlaps with downlink resources of a SBFD time period.

Some resource allocations may have a periodic TDRA, e.g., occurring every 20 symbols, 15 symbols, 2 slots, etc. The length in time between transmission occasions may be referred to as the cycle length or a duty cycle. In some aspects, the duty cycle may be configured to be longer than a number of symbols in both types of resource allocations, e.g., the resource allocation for SBFD slots/symbols and the resource allocation for non-SBFD slots/symbols. As an example, if the resource allocation for the PDSCH transmissions 1401 and 1405 has a TDRA of 10 symbols, and the resource allocation for the PDSCH transmission 1403 is 20 symbols, the cycle length is configured to be greater than 20 symbols. As well, a position for starting a count of a cycle may be provided for the two types of allocations. As an example, each cycle may start the count from a starting symbol of the resource allocation. The starting symbol would be the same for both types of resource allocations and would allow for a period cycle. In some aspects, the count may start from a center symbol of the resource allocation.

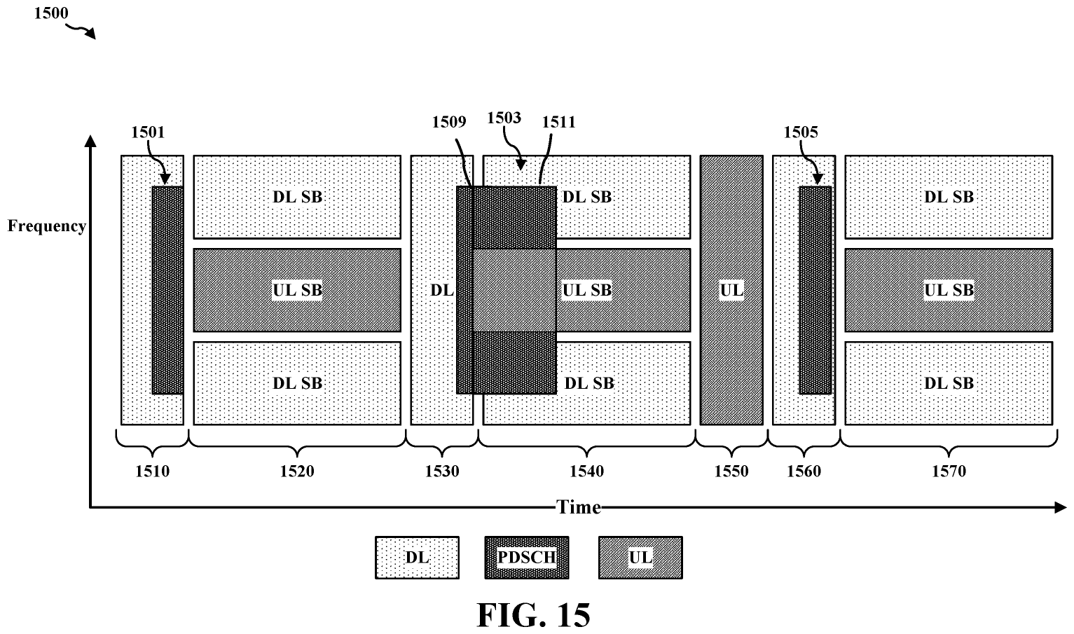

In some aspects one transmission occasion may span different types of time periods, e.g., both an SBFD time period and a non-SBFD or half-duplex time period. In some aspects, the resource allocation may be applied per symbol, so that different symbol types (e.g., SBFD symbols and half-duplex symbols) use different resource allocations. FIG. 15 illustrates an example time resource diagram 1500 having downlink half-duplex time periods 1510, 1530, and 1560; uplink half-duplex time resources 1550; and SBFD time periods 1520, 1540, and 1570. The PDSCH transmission occasions 1501 and 1505 fall within a half-duplex time period and may be based on a first TDRA and/or FDRA associated with a configuration ID. The PDSCH transmission occasion 1503 spans both the SBFD time period 1540 and the half-duplex time period 1530. The portion (e.g., symbols) 1509 of the PDSCH occasion that are within the half-duplex time period 1530 may be based on the first resource allocation, e.g., first TDRA/FDRA associated with the configuration ID, and the portion 1511 (e.g., symbols) of the PDSCH occasion that are within the SBFD time period 1540 may be based on the second TDRA/FDRA associated with the configuration ID. The portion spanning the time gap between the resource types may be based on the second TDRA/FDRA, in some aspects. In other aspects, the PDSCH over the time gap may be based on the first TDRA/FDRA. In some aspects, when a later FDRA, e.g., for the portion 1511, is not fully contained in the earlier FDRA, both parts, e.g., 1509 and 1511, may be transmitted with a DMRS to allow for channel estimation relating to the two portions/different resource allocations. In some aspects, a base station may avoid such types of resource allocation in order to keep the DMRS in the earlier part of the PDSCH transmission. Although this example is described for PDSCH, the example may similarly be applied for PDCCH or CSI-RS. As well, the concept may be similarly applied for PUSCH, PUCCH, or SRS that overlaps with downlink resources of a SBFD time period. The resource allocation may be for periodic, aperiodic, or semi-persistent transmission/occasions. The resource allocation may be for repetitions or transmissions without repetitions. The resource allocation may correspond to a TBoMS.

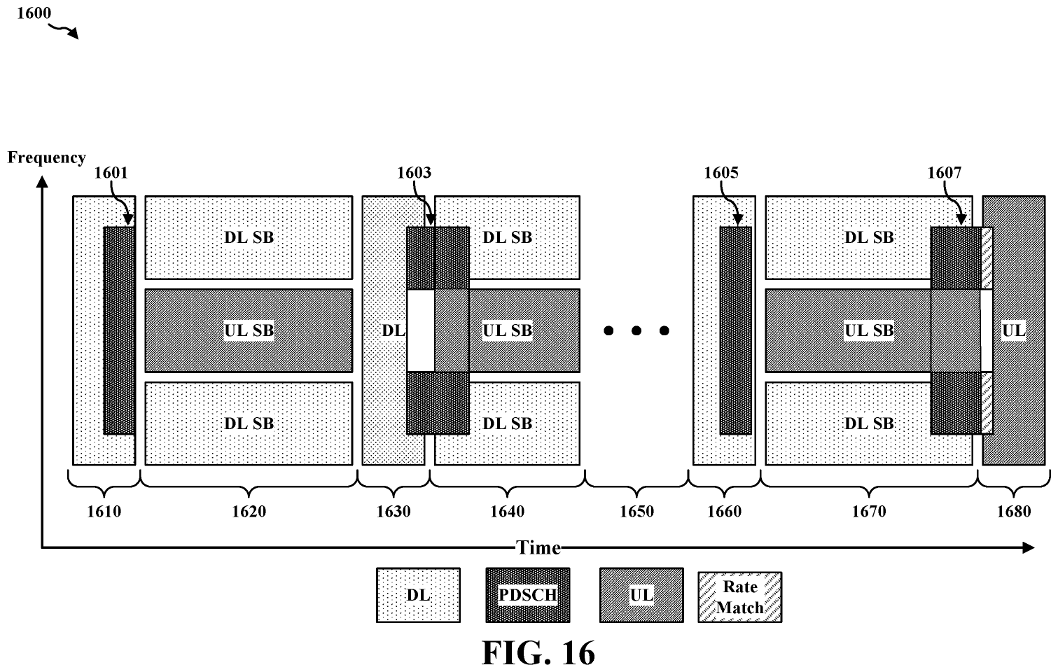

In some aspects, one FDRA of the two resource allocations (e.g., two FDRAs) for the different types of time periods may be prioritized. As an example, the resource allocation for the SBFD time periods may be used if the PDSCH occasion spans both SBFD symbols and half-duplex symbols. The PDSCH may be rate matched around the conflicting resources in both the SBFD time period and the non-SBFD time period. FIG. 16 illustrates an example time resource diagram 1600 having downlink half-duplex time periods 1610, 1630, and 1660; uplink half-duplex time period 1680; and SBFD time periods 1620, 1640, and 1670. The time location 1650 illustrates that the illustrated examples may be separated by any length of time or may occur separately. The PDSCH transmission occasions 1601 and 1605 fall within a half-duplex time period and may be based on a first TDRA and/or FDRA associated with a configuration ID. The PDSCH transmission occasion 1603 spans both the SBFD time period 1640 and the half-duplex time period 1630. The portion (e.g., symbols) of the PDSCH occasion 1603 that are within the SBFD time period 1640 may be based on the second TDRA/FDRA associated with the configuration ID. In this example, the second TDRA/FDRA for the SBFD time periods may be prioritized, and the portion of the PDSCH 1603 in the half-duplex time period 1630 may also be based on the second TDRA/FDRA based on the partial overlap with the SBFD time period. The PDSCH transmission 1607 similarly overlaps with an uplink half-duplex time period 1680, and the PDSCH 1607 may be rate matched around the conflicting uplink resources of the second TDRA/FDRA. Thus, a priority rule may be applied to determine which resource allocation to apply to both types of time resources, e.g., both SBFD and half-duplex symbols, and if a conflict occurs, one or more of the procedures described in connection with FIGS. 7-13 may be applied. Although this example is described for PDSCH, the example may similarly be applied for PDCCH or CSI-RS. As well, the concept may be similarly applied for PUSCH, PUCCH, or SRS that overlaps with downlink resources of a SBFD time period. The resource allocation may be for periodic, aperiodic, or semi-persistent transmission/occasions. The resource allocation may be for repetitions or transmissions without repetitions. The resource allocation may correspond to a TBoMS.

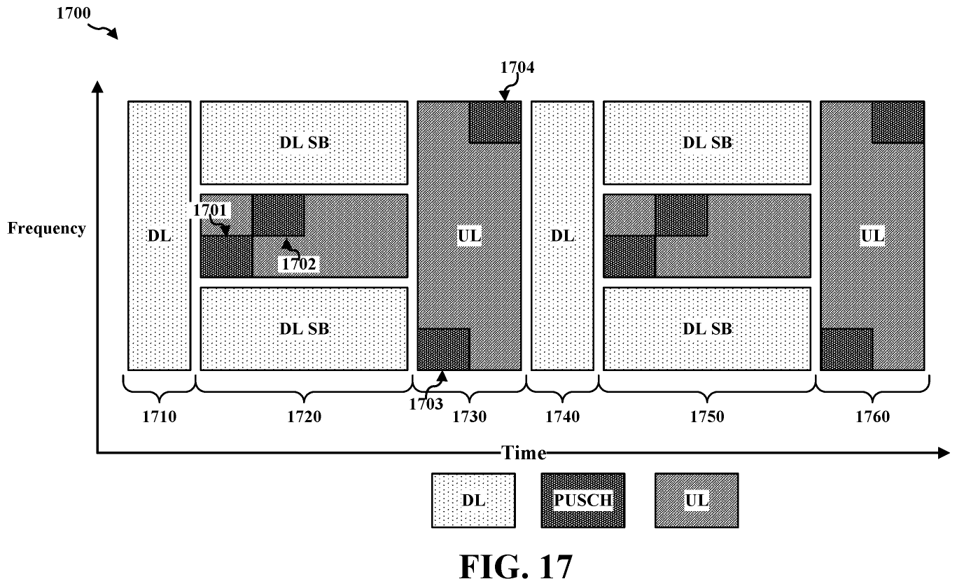

In some aspects, the different resource allocations for the same configuration ID, which are to be applied based on a type of time period (e.g., SBFD slot/symbol or half-duplex slot/symbol) in which a transmission occasion occurs may include different frequency hopping configurations. As an example, the base station may configure two TDRAs/FDRAs, which may be associated with a single configuration ID, and two frequency hopping patterns. FIG. 17 illustrates an example time resource diagram 1700 having downlink half-duplex time periods 1710 and 1740; uplink half-duplex time periods 1730 and 1760; and SBFD time periods 1720 and 1750. The PUSCH transmission that are within the uplink half-duplex time periods 1730 and 1760 may be based on a first resource allocation including a first TDRA and/or FDRA associated with a configuration ID. The PUSCH transmissions within the SBFD time periods 1720 and 1750 may be based on a second resource allocation including the second TDRA/FDRA associated with the configuration ID. As illustrated, the different resource allocations may also include different frequency hopping parameters. For example, in the half-duplex resources, the frequency hopping is between 1703 and 1704, whereas in the SBFD time period 1720, the frequency hopping is shown between 1701 and 1702. The UE may implicitly know on which occasions or symbols to use FDRA1/frequency hopping pattern 1 and in which occasion, e.g., on which symbols, to use FDRA2/frequency hopping pattern 2 based on SBFD time resources and frequency location indication. In some aspects, the different frequency hopping patterns/parameters may include a different frequency offset. The resource allocation may be for periodic, aperiodic, or semi-persistent transmission/occasions. The resource allocation may be for repetitions or transmissions without repetitions. The resource allocation may correspond to a TBoMS.

In some aspects, the base station may configure the PUSCH frequency hopping to provide the different resource allocation between SBFD symbols and non-SBFD symbols. For example, the base station may configure a single FDRA for the two types of time periods (e.g., SBFD and half-duplex), and may configure two frequency hopping patterns, one for each of the SBFD and half-duplex time periods. As an example, for the SBFD time periods, the frequency hopping may include two frequency offset values, whereas the half-duplex time periods may have a single frequency offset value. For example, PUSCH 1703 may be transmitted within an initial frequency offset for the FDRA, whereas the PUSCH 1701 has an offset from the FDRA (e.g., which is shared for both time periods 1720 and 1730) and an additional frequency offset relative to the PUSCH 1701 for the PUSCH 1702. In the half-duplex time period 1730, there is only a single offset between 1703 and 1704. Although this example is described for PUSCH, the example may similarly be applied for PUCCH or SRS. As well, the concept may be similarly applied for PDSCH, PDCCH, or CSI-RS that overlaps with uplink resources of a SBFD time period.

In some aspects, the base station may avoid scheduling certain channels or reference signals to overlap with full-duplex time periods, such as SBFD slots or symbols. As an example, the base station may avoid scheduling PDCCH to overlap with SBFD time periods so that the PDCCH is scheduled to fall within downlink half-duplex periods of time, e.g., downlink symbols. As another example, the base station may avoid scheduling SRS resources to fall within SBFD symbols so that the SRS is scheduled to occur within uplink half-duplex symbols or slots, e.g., uplink symbols. As another example, the base station may avoid scheduling PUCCH resources to fall within SBFD symbols so that the PUCCH is scheduled to occur within uplink half-duplex symbols or slots, e.g., uplink symbols. A UE may identify a scheduling error if the UE receives scheduling for PDCCH, PUCCH, and/or SRS to occur within a SBFD slot or SBFD symbol.

In some aspects, the transmission occasions, e.g., as described in connection with any of FIGS. 7-17 may include occasions in different slots, e.g., multiple occasions on different slots. In some aspects, the multiple occasions may occur within a single slot.

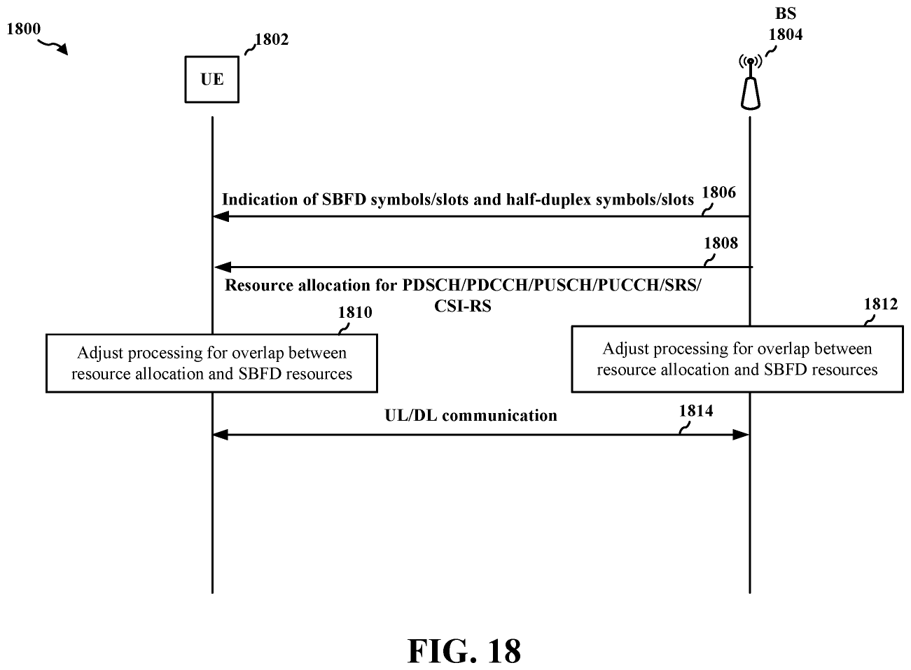

FIG. 18 is an example communication flow 1800 between a UE 1802 and a base station 1804. The aspects performed by the base station may be performed by the base station in aggregation or by one or more disaggregated components of a base station, such as a CU, DU, and/or RU. In some aspects, the base station 1804 may support full-duplex communication, and the UE 1802 may support half-duplex communication. Some of the time periods (e.g., slots or symbols) may be designated for SBFD communication, e.g., by the base station. The communication flow may include the adjusting of processing for resource allocations that are allocated for the UE across SBFD time periods (e.g., slots or symbols) and half-duplex time periods (e.g., slots or symbols). As illustrated at 1806, the base station may indicate the SBFD time periods to the UE 1802.

At 1808, the base station may provide the UE with a resource allocation. The resources allocation may be for PDSCH, PDCCH, PUSCH, PUCCH, SRS, CSI-RS, among other examples. The resource allocation may be for periodic, aperiodic, or semi-persistent transmission/occasions. The resource allocation may be for repetitions or transmissions without repetitions. The resource allocation may correspond to a TBoMS. At least one transmission occasion may be fully within one or more SBFD slots/symbols and another transmission occasion may be fully within one or more non-SBFD slots/symbols. At least one transmission occasion may overlap with both SBFD slots/symbols and non-SBFD slots/symbols.

At 1810, the UE may adjust processing for at least conflicting resources of the at least one resource allocation within the one or more full-duplex time periods or the one or more half-duplex time periods. The adjustment may include any of the aspects described in connection with the resource diagrams of FIGS. 7-17, for example. For example, the UE may rate match an uplink transmission as described in connection with any of FIGS. 7-10, The UE may rate match a downlink transmission as part of reception of the downlink transmission, e.g., which may be referred to as de-rate matching in some aspects. The UE may drop a transmission or reception occasions, such as described in connection with FIG. 12 or 13. The UE may fall back to full use of a resource allocation under one or more conditions, e.g., as described in connection with FIG. 11. The UE may use one of multiple resource allocations or resource allocation types based on a type of slot or symbol (e.g., SBFD or non-SBFD) in which the occasion falls, e.g., as described in connection with FIGS. 14-17. The base station may similarly adjust processing, at 1812 for downlink transmission and/or uplink reception based on any of the aspects described in connection with FIGS. 7-17.

At 1814, the UE 1802 and the base station 1804 may exchange communication, e.g., PDSCH, PDCCH, PUSCH, PUCCH, SRS, and/or CSI-RS based on the adjustments made at 1810 and 1812 to address the overlap of the transmission occasions with SBFD and non-SBFD slots or symbols.

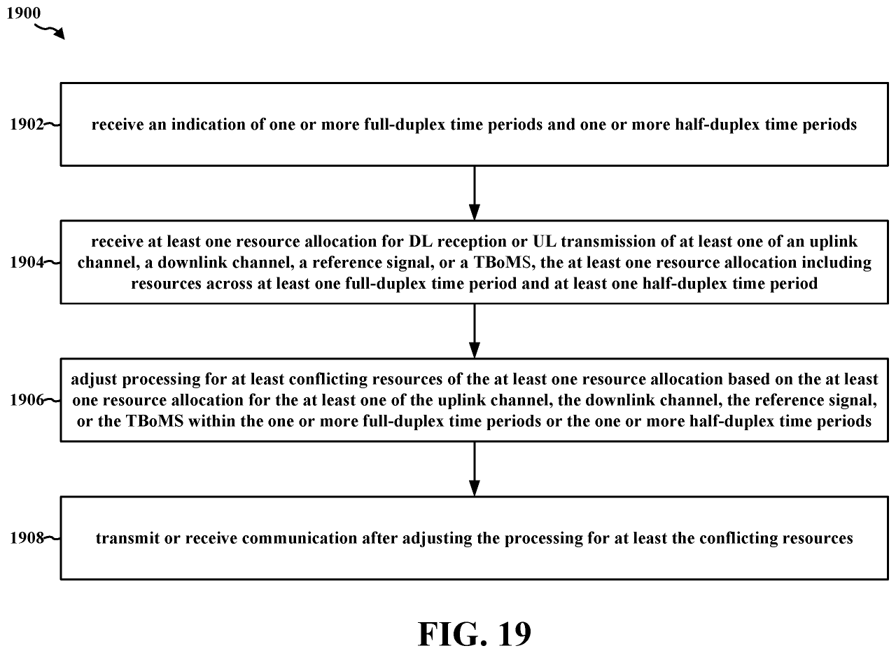

FIG. 19 is a flowchart1 1900 of a method of wireless communication. The method may be performed by a UE (e.g., the UE 104, 350, 1802; the apparatus 2104). The method provides a flexible and robust resource adaptation for uplink and downlink communication that improves communication between a UE and a base station while allowing for full-duplex communication to be supported for at least one of the devices. Aspects of the method enable the UE to process a resource allocation to account for half-duplex and full-duplex time periods. Aspects of the method enable greater flexibility in scheduling resource allocations, as well as in providing for full-duplex time periods. The use of full-duplex time periods may help to reduce latency and improve system capacity, resource utilization, and spectrum efficiency.

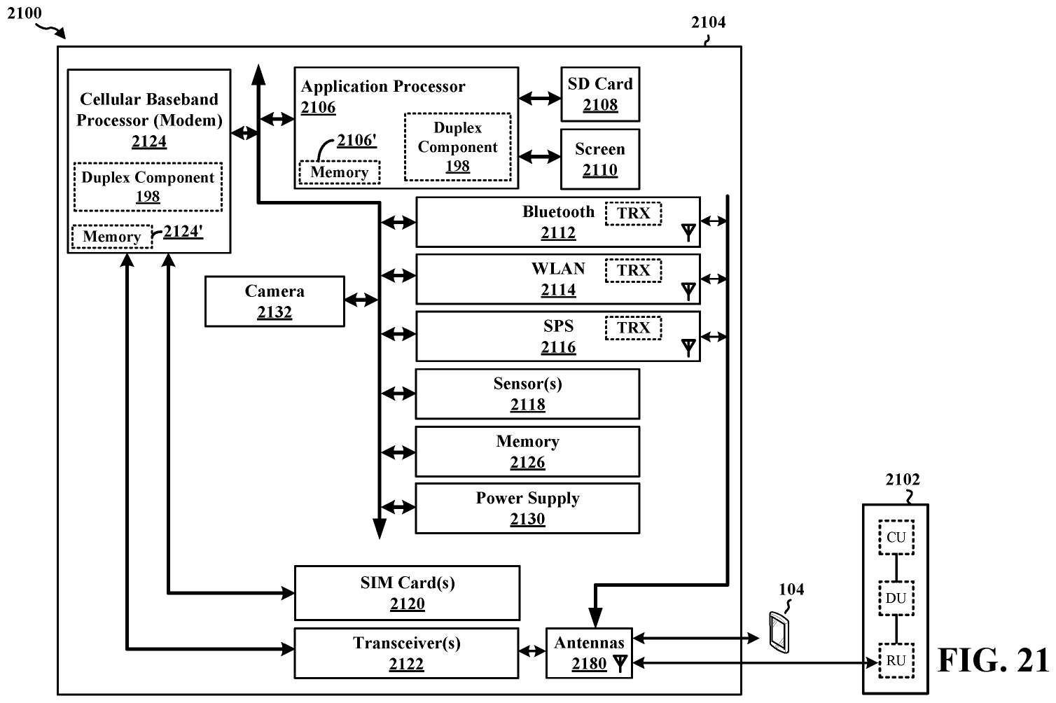

At 1902, the UE receives an indication of one or more full-duplex time periods and one or more half-duplex time periods. Each of the one or more full-duplex time periods corresponds to at least one slot or one or more symbols within a slot. The one or more full-duplex time periods may include sub-band full-duplex resources for full-duplex operation of a base station, and the UE operates in a half-duplex mode. The reception may be performed, e.g., by the component 198 of the apparatus 2104, transceiver, and/or antenna in FIG. 21. FIG. 18 illustrates an example of a UE 1802 receiving an indication of SBFD symbols/slots and half-duplex symbols/slots, at 1806. FIGS. 4A-4D, 5, and 6 illustrate examples aspects relating to half-duplex and SBFD resources.

At 1904, the UE receives at least one resource allocation for downlink reception or uplink transmission of at least one of an uplink channel, a downlink channel, a reference signal, or a TBoMS, the at least one resource allocation that includes resources across at least one full-duplex time period and at least one half-duplex time period. The reception may be performed, e.g., by the component 198 of the apparatus 2104, transceiver, and/or antenna in FIG. 21. FIG. 18 illustrates an example of a UE 1802 receiving a resource allocation, at 1808. Each resource allocation may include at least one of a FDRA and a TDRA for the at least one of the uplink channel, the downlink channel, the reference signal, or the TBoMS. The at least one resource allocation may be for one or more of: a first (PDCCH without repetition across SBFD time periods and non-SBFD time periods, a second PDCCH with the repetition across the SBFD time periods and the non-SBFD time periods, a first physical downlink shared channel (PDSCH) without the repetition across the SBFD time periods and the non-SBFD time periods, a second PDSCH with the repetition across the SBFD time periods and the non-SBFD time periods, a first PUSCH without the repetition across the SBFD time periods and the non-SBFD time periods, a second PUSCH with the repetition across the SBFD time periods and the non-SBFD time periods, a first PUCCH without the repetition across the SBFD time periods and the non-SBFD time periods, a second PUCCH with the repetition across the SBFD time periods and the non-SBFD time periods, a sounding reference signal (SRS) in the SBFD time periods and the non-SBFD time periods, a channel state information reference signal (CSI-RS) the SBFD time periods and the non-SBFD time periods, transport block over multiple slots (TBoMS) that include the SBFD time periods and the non-SBFD time periods, multiple PUSCHs scheduled by a single downlink control information (DCI) across the SBFD time periods and the non-SBFD time periods, or multiple PDSCHs scheduled by the single DCI across the SBFD time periods and the non-SBFD time periods. In some aspects, the at least one transmission occasion (which may refer to both a transmission occasion or a reception occasion) may be fully within one or more SBFD symbols, and another transmission occasion may be fully within one or more non-SBFD symbols.

At 1906, the UE adjusts processing for at least conflicting resources of the at least one resource allocation based on the at least one resource allocation for the at least one of the uplink channel, the downlink channel, the reference signal, or the TBoMS within the one or more full-duplex time periods or the one or more half-duplex time periods. The adjustment may be performed, e.g., by the component 198 of the apparatus 2104 in FIG. 21. FIG. 18 illustrates a UE 1802 that adjusts the processing of a resource allocation, at 1810. The processing may include any of the aspects described in connection with the examples in FIGS. 7-17.

In some aspects, the adjusting processing may be based on a defined rule. In some aspects, adjusting the processing may include rate matching the communication in a full-duplex time period or a half-duplex time period to avoid at least the conflicting resources in at least the full-duplex time period or at least the half-duplex time period. In some aspects, the rate matching may be for a single transmission or reception occasion. FIGS. 7 and 8 illustrate examples of a single occasion adjustment. The conflicting resource may correspond to an uplink sub-band of a SBFD slot or symbol that conflicts with reception of a PDCCH, a PDSCH, or a CSI-RS. The conflicting resource may correspond to a downlink sub-band of a SBFD slot or symbol that conflicts with transmission of a PUCCH, a PUSCH, or an SRS.

In some aspects, adjusting the processing may include rate matching the communication in the one or more half-duplex time periods and the one or more full-duplex time periods to avoid one or more conflicting resource blocks in the full-duplex time period. As an example, the rate matching may be performed for multiple transmission or reception occasions, including one or more occasions that do not include the one or more conflicting resource blocks. FIGS. 9 and 10 illustrate examples of occasion common adaptation for multiple occasions, including those that do not overlap with conflicting resources. In some aspects, the rate matching may include rate matching the communication in a full-duplex time period or a half-duplex time period to avoid at least the conflicting resources in at least the full-duplex time period or at least the half-duplex time period and around at least one of: a time gap between the at least one full-duplex time period and the at least one half-duplex time period, or a guard band between a downlink sub-band and an uplink sub-band frequency resources in a SBFD slot or symbol. In some aspects, the rate matching may include rate matching the communication in a full-duplex time period or a half-duplex time period to avoid at least the conflicting resources in at least the full-duplex time period or at least the half-duplex time period, wherein the rate matching is based on a rate match pattern for the downlink reception, an uplink cancellation indication (UCLI) for the uplink transmission, or an uplink rate match pattern for the uplink transmission.

In some aspects, adjusting the processing may include transmitting or receiving the communication over conflicting full-duplex resources based on at least one of: transmitting or receiving a downlink signal over the conflicting full-duplex resources based on a first condition that a downlink signal resource allocation for the downlink signal is in a downlink symbol or a flexible symbol that occurs in a SBFD time period or transmitting or receiving an uplink signal over the conflicting full-duplex resources based on a second condition that an uplink signal resource allocation for the uplink signal is in the flexible symbol that occurs in the SBFD time period and occasion common adaptation is applied across multiple transmission occasions. FIG. 11 illustrates example aspects in which the UE may fallback to or update to downlink only resources or use of flexible resources for uplink transmission based on one or more conditions. In some aspects, the UE may further receive a configuration to disregard the conflicting full-duplex resources, wherein the UE transmits or receives the communication over the conflicting full-duplex resources based on the configuration.

In some aspects, adjusting the processing may include dropping a transmission or reception occasion that includes conflicting full-duplex resources in a full-duplex time period or includes conflicting half-duplex resources in a half-duplex time period. FIGS. 12 and 13 illustrates an example of dropping transmission or reception occasions based on conflicting SBFD resources.

In some aspects, the at least one resource allocation includes a first type of resource allocation associated with the one or more full-duplex time periods and a second type of resource allocation associated with the one or more half-duplex time periods, wherein adjusting the processing includes applying a resource allocation type based on a time period type. FIGS. 14-16 illustrate examples of the use of different resource allocations based on SBFD slots/symbols and non-SBFD slots/symbols. In some aspects, a cycle duration for the at least one resource allocation is longer than a number of symbols of the first type of resource allocation and the second type of resource allocation. In some aspects, a cycle duration is counted from a starting symbol per occasion or a center symbol per occasion for both the first type of resource allocation and the second type of resource allocation.

In some aspects, the first type of resource allocation may be applied to a full-duplex symbol, and the second type of resource allocation is applied to a half-duplex symbol. In some aspects, the first type of resource allocation is applied across a first resource allocation if at least one symbol of the first resource allocation overlaps with a full-duplex time slot or a full-duplex symbol. In some aspects, the first type of resource allocation or the second type of resource allocation is prioritized and applied across both full-duplex time periods and half-duplex time periods. In some aspects, adjusting the processing may further include rate matching the communication around conflicting resources. In some aspects, the first type of resource allocation may include a first frequency hopping pattern associated with the one or more full-duplex time periods and the second type of resource allocation further include a second frequency hopping pattern associated with the one or more half-duplex time periods. FIG. 17 illustrates an example of different frequency hopping patterns for SBFD slots/symbols and non-SBFD slots/symbols. In some aspects, adjusting the processing may include applying the first frequency hopping pattern or the second frequency hopping pattern based on the time period type. In some aspects, the first frequency hopping pattern includes a different the frequency hopping offset than the second frequency hopping pattern. In some aspects, the first type of resource allocation may include a same frequency domain resource allocation as the second type of resource allocation and a different frequency hopping pattern than the second type of resource allocation. In some aspects, the second type of resource allocation may include a first offset for frequency hopping and the first type of resource allocation includes two offsets for the frequency hopping.

At 1908, the UE transmits or receives communication after adjusting the processing for at least the conflicting resources. For example, the UE may transmit PUSCH, PUCCH, and/or SRS. The UE may receive PDSCH, PDCCH, and/or CSI-RS, among other examples. The transmission or reception may be performed, e.g., by the component 198, transceiver, and/or antenna of the apparatus 2104 in FIG. 21. FIG. 18 illustrates an example of a UE 1802 transmitting or receiving communication, at 1814, after such an adjustment.

In some aspects, the UE may identify an error based on an overlap between a resource allocation for a channel type or a reference signal that overlaps with a full-duplex sub-band resource of a different direction or overlaps with a half-duplex resource of the different direction.

The method may further include any of the aspects described in connection with FIGS. 4-17, for example.

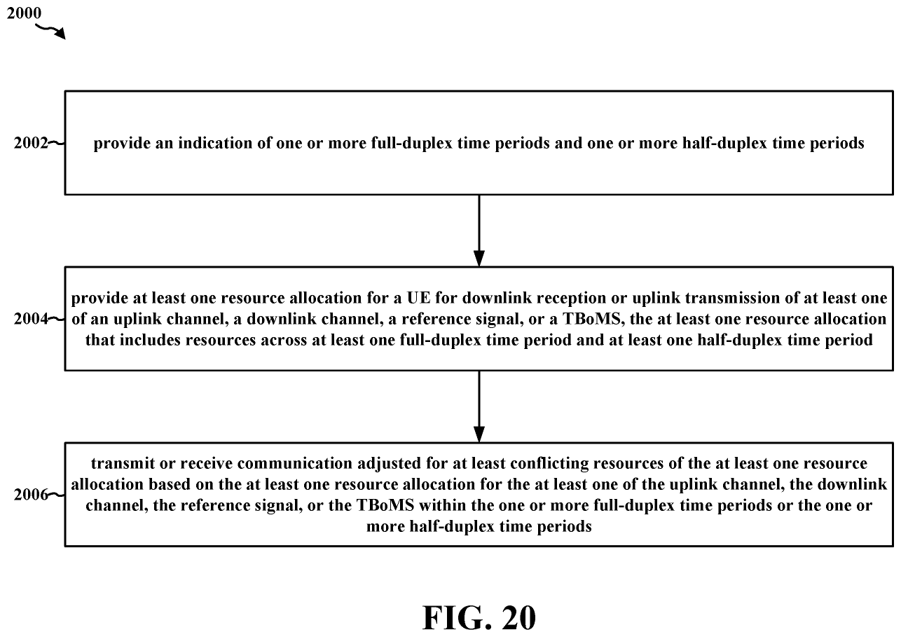

FIG. 20 is a flowchart 2000 of a method of wireless communication. The method may be performed by a base station (e.g., the base station 102, 310; the CU 110, DU 10; RU 140; the network entity 2202. The method provides a flexible and robust resource adaptation for uplink and downlink communication that improves communication between a UE and a base station while allowing for full-duplex communication to be supported for at least one of the devices. Aspects of the method enable resource allocations to account for half-duplex and full-duplex time periods. Aspects of the method enable greater flexibility in scheduling resource allocations, as well as in providing for full-duplex time periods. The use of full-duplex time periods may help to reduce latency and improve system capacity, resource utilization, and spectrum efficiency.

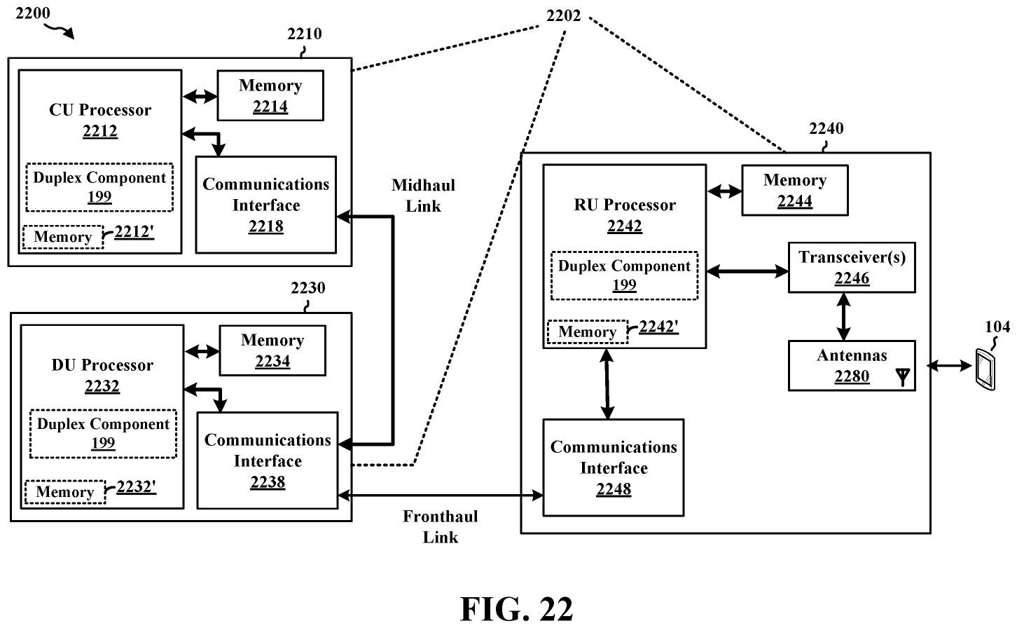

At 2002, the network node provides an indication of one or more full-duplex time periods and one or more half-duplex time periods. Each of the one or more full-duplex time periods corresponds to at least one slot or one or more symbols within a slot. The one or more full-duplex time periods may include sub-band full-duplex resources for full-duplex operation of a base station, and the UE operates in a half-duplex mode. The providing may be performed, e.g., by the component 199 of the network entity 2202 in FIG. 22. FIG. 18 illustrates an example of a base station 1804 transmitting an indication of SBFD symbols/slots and half-duplex symbols/slots, at 1806, to a UE 1802. FIGS. 4A-4D, 5, and 6 illustrate examples aspects relating to half-duplex and SBFD resources.

At 2004, the network node provides at least one resource allocation for a UE for downlink reception or uplink transmission of at least one of an uplink channel, a downlink channel, a reference signal, or a TBoMS, the at least one resource allocation that includes resources across at least one full-duplex time period and at least one half-duplex time period. The providing may be performed, e.g., by the component 199 of the network entity 2202 in FIG. 22. FIG. 18 illustrates an example of a base station transmitting a resource allocation to a UE 1802, at 1808. Each resource allocation may include at least one of a FDRA and a TDRA for the at least one of the uplink channel, the downlink channel, the reference signal, or the TBoMS. The at least one resource allocation may be for one or more of: a first PDCCH without repetition across SBFD time periods and non-SBFD time periods, a second PDCCH with the repetition across the SBFD time periods and the non-SBFD time periods, a first PDSCH without the repetition across the SBFD time periods and the non-SBFD time periods, a second PDSCH with the repetition across the SBFD time periods and the non-SBFD time periods, a first PUSCH without the repetition across the SBFD time periods and the non-SBFD time periods, a second PUSCH with the repetition across the SBFD time periods and the non-SBFD time periods, a first PUCCH without the repetition across the SBFD time periods and the non-SBFD time periods, a second PUCCH with the repetition across the SBFD time periods and the non-SBFD time periods, an SRS in the SBFD time periods and the non-SBFD time periods, a CSI-RS the SBFD time periods and the non-SBFD time periods, TBoMS that include the SBFD time periods and the non-SBFD time periods, multiple PUSCHs scheduled by a single DCI across the SBFD time periods and the non-SBFD time periods, or multiple PDSCHs scheduled by the single DCI across the SBFD time periods and the non-SBFD time periods. At least one transmission occasion (which may refer to an occasion for transmission or an occasion to receive a transmission) may be fully within one or more SBFD symbols and another transmission occasion may be fully within one or more non-SBFD symbols.

At 2006, the network entity transmits or receives, e.g., communicates, communication adjusted for at least conflicting resources of the at least one resource allocation based on the at least one resource allocation for the at least one of the uplink channel, the downlink channel, the reference signal, or the TBoMS within the one or more full-duplex time periods or the one or more half-duplex time periods. The transmitting or receiving or communicating may be performed, e.g., by the component 199 of the network entity 2202 in FIG. 22. FIG. 18 illustrates an example of a base station 1804 transmitting or receiving communication, at 1814, based on such an adjustment. The communication may be adjusted based on any of the aspects described in connection with the examples in FIGS. 7-17.

An adjustment for the at least conflicting resources may be based on a defined rule. The communication may be rate matched in a full-duplex time period to avoid at least the conflicting resources in at least the full-duplex time period. The rate-matching may be for a single transmission or reception occasion, e.g., the communication may be for a single transmission or reception occasion. FIGS. 7 and 8 illustrate examples of occasion specific rate matching for the conflicting resources. The communication may be rate matched in the full-duplex time period and the half-duplex time period to avoid at least the conflicting resources in at least the full-duplex time period or at least the half-duplex time period. The communication may be for multiple transmission or reception occasions, e.g., the communication may be rate matched in multiple transmission or reception occasions, including one or more occasions that do not include the one or more conflicting resource blocks. FIGS. 9 and 10 illustrate examples of occasion common rate matching. The conflicting resource may correspond to an uplink sub-band of a SBFD slot or symbol that conflicts with transmission of a PDCCH, a PDSCH, or a CSI-RS. The conflicting resource may correspond to a downlink sub-band of a SBFD slot or symbol that conflicts with reception of a PUCCH, a PUSCH, or a sounding reference signal (SRS). The communication may be rate matched around at least one of: a time gap between the at least one full-duplex time period and the at least one half-duplex time period, or a guard band between a downlink sub-band and an uplink sub-band frequency resources in a SBFD slot or symbol. The communication may be rate matched based on a rate match pattern for the downlink reception, an uplink cancellation indication (UCLI) for the uplink transmission, or an uplink rate match pattern for the uplink transmission. The communication may be transmitted or received over conflicting full-duplex resources based on at least one of: transmitting or receiving a downlink signal over the conflicting full-duplex resources based on a first condition that a downlink signal resource allocation for the downlink signal is in a downlink symbol or a flexible symbol that occurs in a SBFD time period, or transmitting or receiving an uplink signal over the conflicting full-duplex resources based on a second condition that an uplink signal resource allocation for the uplink signal is in the flexible symbol that occurs in the SBFD time period and occasion common adaptation is applied across multiple transmission occasions. FIG. 11 illustrates example aspects of falling back to the use of downlink or uplink resources that overlap with SBFD resources based on one or more conditions. The network entity may provide a configuration to disregard the conflicting full-duplex resources, wherein the communication is transmitted or received over the conflicting full-duplex resources based on the configuration.

In some aspects, the transmitting or receiving may include dropping a transmission or reception occasion that includes conflicting full-duplex resources in a full-duplex time period or includes conflicting half-duplex resources in a half-duplex time period. FIG. 12 and FIG. 13 illustrate examples of dropping based on conflicting SBFD resources.

In some aspects, the at least one resource allocation may include a first type of resource allocation associated with the one or more full-duplex time periods and a second type of resource allocation associated with the one or more half-duplex time periods, wherein the communication is based on a resource allocation type based on a time period type. FIGS. 14-17 illustrate examples aspects of using different allocations based on SBFD slots/symbols and non-SBFD slots/symbols. In some aspects, a cycle duration for the at least one resource allocation is longer than a number of symbols of the first type of resource allocation and the second type of resource allocation. In some aspects, a cycle duration is counted from a starting symbol per occasion or a center symbol per occasion for both the first type of resource allocation and the second type of resource allocation. In some aspects, the first type of resource allocation is applied to a full-duplex symbol, and the second type of resource allocation is applied to a half-duplex symbol. In some aspects, the first type of resource allocation is applied across a first resource allocation if at least one symbol of the first resource allocation overlaps with a full-duplex time slot or a full-duplex symbol. In some aspects, the first type of resource allocation or the second type of resource allocation is prioritized and applied across both full-duplex time periods and half-duplex time periods. In some aspects, the communication is rate matched around conflicting resources.

In some aspects, the first type of resource allocation includes a first frequency hopping pattern associated with the one or more full-duplex time periods and the second type of resource allocation further include a second frequency hopping pattern associated with the one or more half-duplex time periods. FIG. 17 illustrates an example of different frequency hopping patterns for SBFD slots/symbols and non-SBFD slots/symbols. In some aspects, the communication includes the first frequency hopping pattern or the second frequency hopping pattern based on the time period type. In some aspects, the first frequency hopping pattern includes a different frequency hopping offset than the second frequency hopping pattern. In some aspects, the first type of resource allocation includes a same frequency domain resource allocation as the second type of resource allocation and a different frequency hopping pattern than the second type of resource allocation. In some aspects, the second type of resource allocation includes a first offset for frequency hopping and the first type of resource allocation includes two offsets for the frequency hopping.

In some aspects, the network entity skips scheduling a channel type or a reference signal with a resource allocation that overlaps with a full-duplex resource of a different direction.

The method may further include any of the aspects described in connection with FIGS. 4-17, for example.

FIG. 21 is a diagram 2100 illustrating an example of a hardware implementation for an apparatus 2104. The apparatus 2104 may be a UE, a component of a UE, or may implement UE functionality. In some aspects, the apparatus 2104 may include at least one cellular baseband processor 2124 (which may also be referred to as processor circuitry or a modem) coupled to one or more transceivers 2122 (e.g., cellular RF transceiver). The cellular baseband processor 2124 may include at least one on-chip memory 2124′ (which may also be referred to as memory circuitry). In some aspects, the apparatus 2104 may further include one or more subscriber identity modules (SIM) cards 2120 and at least one application processor 2106 coupled to a secure digital (SD) card 2108 and a screen 2110. The application processor 2106 may include at least one on-chip memory 2106′. In some aspects, the apparatus 2104 may further include a Bluetooth module 2112, a WLAN module 2114, an SPS module 2116 (e.g., GNSS module), one or more sensor modules 2118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2126, a power supply 2130, and/or a camera 2132. The Bluetooth module 2112, the WLAN module 2114, and the SPS module 2116 may include an on-chip transceiver (TRX) (or in some cases, just a receiver (RX)). The Bluetooth module 2112, the WLAN module 2114, and the SPS module 2116 may include their own dedicated antennas and/or utilize the antennas 2180 for communication. The cellular baseband processor 2124 communicates through the transceiver(s) 2122 via one or more antennas 2180 with the UE 104 and/or with an RU associated with a network entity 2102. The cellular baseband processor 2124 and the application processor 2106 may each include a computer-readable medium/memory 2124′, 2106′, respectively. The additional memory modules 2126 may also be considered a computer-readable medium/memory. Each computer-readable medium/memory 2124′, 2106′, 2126 may be non-transitory. The cellular baseband processor 2124 and the application processor 2106 are each responsible for general processing, including the execution of software stored on the computer-readable medium/memory. The software, when executed by the cellular baseband processor 2124/application processor 2106, causes the cellular baseband processor 2124/application processor 2106 to perform the various functions described supra. The cellular baseband processor(s) 2124 and the application processor(s) 2106 are configured to perform the various functions described supra based at least in part of the information stored in the memory. That is, the cellular baseband processor(s) 2124 and the application processor(s) 2106 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 2124/application processor(s) 2106 when executing software. The cellular baseband processor(s) 2124/application processor(s) 2106 may be a component of the UE 350 and may include the at least one memory 360 and/or at least one of the TX processor 368, the RX processor 356, and the controller/processor 359. In one configuration, the apparatus 2104 may be at least one processor chip (modem and/or application) and include just the cellular baseband processor(s) 2124 and/or the application processor(s) 2106, and in another configuration, the apparatus 2104 may be the entire UE (e.g., see UE 350 of FIG. 3) and include the additional modules of the apparatus 2104.

As discussed supra, the component 198 may be configured to receive an indication of one or more full-duplex time periods and one or more half-duplex time periods; receive at least one resource allocation for downlink reception or uplink transmission, the at least one resource allocation that includes resources across at least one full-duplex time period and at least one half-duplex time period; adjust processing for at least conflicting resources of the at least one resource allocation within the one or more full-duplex time periods or the one or more half-duplex time periods; and transmit or receive communication after adjusting the processing for at least the conflicting resources. The component 198 may be further configure to perform any of the aspects described in connection with the flowchart in FIG. 19 and/or any of the aspects performed by the UE in the communication flow in FIG. 18 or in connection with the examples in FIGS. 7-17. The component 198 may be within the cellular baseband processor(s) 2124, the application processor(s) 2106, or both the cellular baseband processor(s) 2124 and the application processor(s) 2106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 2104 may include a variety of components configured for various functions. In one configuration, the apparatus 2104, and in particular the cellular baseband processor 2124 and/or the application processor 2106, may include means for receiving an indication of one or more full-duplex time periods and one or more half-duplex time periods; means for receiving at least one resource allocation for downlink reception or uplink transmission, the at least one resource allocation that includes resources across at least one full-duplex time period and at least one half-duplex time period; means for adjusting processing for at least conflicting resources of the at least one resource allocation within the one or more full-duplex time periods or the one or more half-duplex time periods; and means for means for transmitting or receiving communication after adjusting the processing for at least the conflicting resources. The apparatus 2104 may further include means for performing any of the aspects described in connection with the flowchart in FIG. 19 and/or any of the aspects performed by the UE in the communication flow in FIG. 18 or in connection with the examples in FIGS. 7-17. The means may be the component 198 of the apparatus 2104 configured to perform the functions recited by the means. As described supra, the apparatus 2104 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 22 is a diagram 2200 illustrating an example of a hardware implementation for a network entity 2202. The network entity 2202 may be a BS, a component of a BS, or may implement BS functionality. The network entity 2202 may include at least one of a CU 2210, a DU 2230, or an RU 2240. For example, depending on the layer functionality handled by the component 199, the network entity 2202 may include the CU 2210; both the CU 2210 and the DU 2230; each of the CU 2210, the DU 2230, and the RU 2240; the DU 2230; both the DU 2230 and the RU 2240; or the RU 2240.

The CU 2210 may include at least one CU processor 2212. The CU processor 2212 may include at least one on-chip memory 2212′. In some aspects, the CU 2210 may further include additional memory modules 2214 and a communications interface 2218. The CU 2210 communicates with the DU 2230 through a midhaul link, such as an F1 interface. The DU 2230 may include at least one DU processor 2232. The DU processor 2232 may include at least one on-chip memory 2232′. In some aspects, the DU 2230 may further include additional memory modules 2234 and a communications interface 2238. The DU 2230 communicates with the RU 2240 through a fronthaul link. The RU 2240 may include at least one RU processor 2242. The RU processor 2242 may include at least one on-chip memory 2242′. In some aspects, the RU 2240 may further include additional memory modules 2244, one or more transceivers 2246, antennas 2280, and a communications interface 2248. The RU 2240 communicates with the UE 104. The on-chip memory 2212′, 2232′, 2242′ and the additional memory modules 2214, 2234, 2244 may each be considered a computer-readable medium/memory, and may also be referred to as memory circuitry. Each computer-readable medium/memory may be non-transitory. Each of the processors 2212, 2232, 2242 is responsible for general processing, including the execution of software stored on the computer-readable medium/memory. The software, when executed by the corresponding processor(s) causes the processor(s) (which may also be referred to as processor circuitry) to perform the various functions described supra. The computer-readable medium/memory may also be used for storing data that is manipulated by the processor(s) when executing software.

As discussed supra, the component 199 may be configured to provide an indication of one or more full-duplex time periods and one or more half-duplex time periods; provide at least one resource allocation for a UE for downlink reception or uplink transmission, the at least one resource allocation that includes resources across at least one full-duplex time period and at least one half-duplex time period; and transmit or receive communication adjusted for at least conflicting resources of the at least one resource allocation within the one or more full-duplex time periods or the one or more half-duplex time periods. The component 199 may be further configured to perform any of the aspects described in connection with the flowchart in FIG. 20 and/or any of the aspects performed by the base station in the communication flow in FIG. 18 or in connection with the examples in FIGS. 7-17. The component 199 may be within one or more processors of one or more of the CU 2210, DU 2230, and the RU 2240.

The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2202 may include a variety of components configured for various functions. In one configuration, the network entity 2202 may include means for providing an indication of one or more full-duplex time periods and one or more half-duplex time periods; means for providing at least one resource allocation for a UE for downlink reception or uplink transmission, the at least one resource allocation that includes resources across at least one full-duplex time period and at least one half-duplex time period; and means for transmitting or receiving communication adjusted for at least conflicting resources of the at least one resource allocation within the one or more full-duplex time periods or the one or more half-duplex time periods. The network entity may further include means for performing any of the aspects described in connection with the flowchart in FIG. 20 and/or any of the aspects performed by the base station in the communication flow in FIG. 18 or in connection with the examples in FIGS. 7-17. The means may be the component 199 of the network entity 2202 configured to perform the functions recited by the means. As described supra, the network entity 2202 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, comprising: receiving an indication of one or more full-duplex time periods and one or more half-duplex time periods; receiving at least one resource allocation for downlink reception or uplink transmission of at least one of an uplink channel, a downlink channel, a reference signal, or a transport block over multiple slots (TBoMS), the at least one resource allocation that includes resources across at least one full-duplex time period and at least one half-duplex time period; adjusting processing for at least conflicting resources of the at least one resource allocation based on the at least one resource allocation for the at least one of the uplink channel, the downlink channel, the reference signal, or the TBoMS within the one or more full-duplex time periods or the one or more half-duplex time periods; and transmit or receive communication after adjusting the processing for at least the conflicting resources.

In aspect 2, the method of aspect 1 further includes that each of the one or more full-duplex time periods corresponds to at least one slot or one or more symbols within a slot.

In aspect 3, the method of aspect 1 or 2 further includes that the one or more full-duplex time periods include sub-band full-duplex resources for full-duplex operation of a base station, and the UE operates in a half-duplex mode.

In aspect 4, the method of any of aspects 1-3 further includes that each resource allocation includes at least one of a FDRA and a TDRA for the at least one of the uplink channel, the downlink channel, the reference signal, or the TBoMS.

In aspect 5, the method of any of aspects 1-4 further includes that the at least one resource allocation is for one or more of: a first PDCCH without repetition across SBFD time periods and non-SBFD time periods, a second PDCCH with the repetition across the SBFD time periods and the non-SBFD time periods, a first PDSCH without the repetition across the SBFD time periods and the non-SBFD time periods, a second PDSCH with the repetition across the SBFD time periods and the non-SBFD time periods, a first PUSCH without the repetition across the SBFD time periods and the non-SBFD time periods, a second PUSCH with the repetition across the SBFD time periods and the non-SBFD time periods, a first PUCCH without the repetition across the SBFD time periods and the non-SBFD time periods, a second PUCCH with the repetition across the SBFD time periods and the non-SBFD time periods, a SRS in the SBFD time periods and the non-SBFD time periods, a CSI-RS the SBFD time periods and the non-SBFD time periods, TBoMS that include the SBFD time periods and the non-SBFD time periods, multiple PUSCHs scheduled by a single downlink control information (DCI) across the SBFD time periods and the non-SBFD time periods, or multiple PDSCHs scheduled by the single DCI across the SBFD time periods and the non-SBFD time periods.

In aspect 6, the method of aspect 5 further includes that at least one transmission occasion is fully within one or more SBFD symbols and another transmission occasion is fully within one or more non-SBFD symbols.

In aspect 7, the method of any of aspects 1-6 further includes that the adjusting processing is based on a defined rule.

In aspect 8, the method of any of aspects 1-7 further includes rate matching the communication in a full-duplex time period or a half-duplex time period to avoid at least the conflicting resources in at least the full-duplex time period or at least the half-duplex time period.

In aspect 9, the method of aspect 8 further includes that the rate-matching is for a single transmission or reception occasion.

In aspect 10, the method of aspect 8 or 9 further includes that the conflicting resource correspond to an uplink sub-band of a SBFD slot or symbol that conflicts with reception of a PDCCH, a PDSCH, or a CSI-RS.

In aspect 11, the method of aspect 8 or 9 further includes that the conflicting resource correspond to an downlink sub-band of a SBFD slot or symbol that conflicts with transmission of a PUCCH, a PUSCH, or a SRS.

In aspect 12, the method of any of aspects 8-11 further includes rate matching the communication in the one or more half-duplex time periods and the one or more full-duplex time periods to avoid one or more conflicting resource blocks in the full-duplex time period.

In aspect 13, the method of aspect 12 further includes that the rate matching is performed for multiple transmission or reception occasions, including one or more occasions that do not include the one or more conflicting resource blocks.

In aspect 14, the method of any of aspects 1-13 further includes rate matching the communication in a full-duplex time period or a half-duplex time period to avoid at least the conflicting resources in at least the full-duplex time period or at least the half-duplex time period and around at least one of: a time gap between the at least one full-duplex time period and the at least one half-duplex time period, or a guard band between a downlink subband and an uplink subband frequency resources in a SBFD slot or symbol.

In aspect 15, the method of any of aspects 1-14 further includes that the rate matching includes rate matching the communication in a full-duplex time period or a half-duplex time period to avoid at least the conflicting resources in at least the full-duplex time period or at least the half-duplex time period, based on a rate match pattern for the downlink reception, an UCLI for the uplink transmission, or an uplink rate match pattern for the uplink transmission.

In aspect 16, the method of any of aspects 1-7 further includes adjusting the processing includes transmitting or receiving the communication over conflicting full-duplex resources based on at least one of: transmitting or receiving a downlink signal over the conflicting full-duplex resources based on a first condition that a downlink signal resource allocation for the downlink signal is in a downlink symbol or a flexible symbol that occurs in a SBFD time period, or transmitting or receiving an uplink signal over the conflicting full-duplex resources based on a second condition that an uplink signal resource allocation for the uplink signal is in the flexible symbol that occurs in the SBFD time period and occasion common adaptation is applied across multiple transmission occasions.

In aspect 17, the method of aspect 16 further includes receiving a configuration to disregard the conflicting full-duplex resources, wherein the UE transmits or receives the communication over the conflicting full-duplex resources based on the configuration.

In aspect 18, the method of any of aspects 1-7 further includes dropping a transmission or reception occasion that includes conflicting full-duplex resources in a full-duplex time period or includes conflicting half-duplex resources in a half-duplex time period.

In aspect 19, the method of any of aspects 1-18 further includes each resource allocation comprises at least one of a TDRA or a FDRA.

In aspect 20, the method of aspect 19 further includes that the at least one resource allocation includes a first type of resource allocation associated with the one or more full-duplex time periods and a second type of resource allocation associated with the one or more half-duplex time periods, wherein adjusting the processing includes applying a resource allocation type based on a time period type.

In aspect 21, the method of aspect 20 further includes that a cycle duration for the at least one resource allocation is longer than a number of symbols of the first type of resource allocation and the second type of resource allocation.

In aspect 22, the method of aspect 20 further includes that a cycle duration is counted from a starting symbol per occasion or a center symbol per occasion for both the first type of resource allocation and the second type of resource allocation.

In aspect 23, the method of any of aspects 20-22 further includes that the first type of resource allocation is applied to a full-duplex symbol, and the second type of resource allocation is applied to a half-duplex symbol.

In aspect 24, the method of any of aspects 20-22 further includes that the first type of resource allocation is applied across a first resource allocation if at least one symbol of the first resource allocation overlaps with a full-duplex time slot or a full-duplex symbol.

In aspect 25, the method of any of aspects 20-22 further includes that the first type of resource allocation or the second type of resource allocation is prioritized and applied across both full-duplex time periods and half-duplex time periods.

In aspect 26, the method of aspect 25 further includes rate matching the communication around conflicting resources.

In aspect 27, the method of any of aspects 20-26 further includes that the first type of resource allocation includes a first frequency hopping pattern associated with the one or more full-duplex time periods and the second type of resource allocation further include a second frequency hopping pattern associated with the one or more half-duplex time periods.

In aspect 28, the method of aspect 27 further includes adjusting the processing includes applying the first frequency hopping pattern or the second frequency hopping pattern based on the time period type.

In aspect 29, the method of aspect 28 further includes that the first frequency hopping pattern includes a different frequency hopping offset than the second frequency hopping pattern.

In aspect 30, the method of aspect 28 or 29 further includes that the first type of resource allocation includes a same frequency domain resource allocation as the second type of resource allocation and a different frequency hopping pattern than the second type of resource allocation.

In aspect 31, the method of aspect 30 further includes that the second type of resource allocation includes a first offset for frequency hopping and the first type of resource allocation includes two offsets for the frequency hopping.

In aspect 32, the method of any of aspects 1-7 further includes identifying an error based on an overlap between a resource allocation for a channel type or a reference signal that overlaps with a full-duplex subband resource of a different direction or overlaps with a half-duplex resource of the different direction.

Aspect 33 is an apparatus for wireless communication at a UE, the apparatus including memory, and at least one processor coupled to the memory and, based at least in part on information stored in the memory, the at least one processor is configured to perform the method of any of aspects 1-32.

Aspect 34 is an apparatus for wireless communication at a UE, the apparatus includes means for performing the method of any of aspects 1-32.

In aspect 35, the apparatus of aspect 33 or 34 further including at least one transceiver.

Aspect 36 is a computer-readable medium, e.g., non-transitory computer-readable medium, storing computer executable code at a UE, the code when executed by at least one processor causes the UE to perform the method of any of aspects 1-32.

Aspect 37 is a method of wireless communication at a network node, comprising: providing an indication of one or more full-duplex time periods and one or more half-duplex time periods; providing at least one resource allocation for a UE for downlink reception or uplink transmission of at least one of an uplink channel, a downlink channel, a reference signal, or a transport block over multiple slots (TBoMS), the at least one resource allocation that includes resources across at least one full-duplex time period and at least one half-duplex time period; and transmitting or receiving communication adjusted for at least conflicting resources of the at least one resource allocation based on the at least one resource allocation for the at least one of the uplink channel, the downlink channel, the reference signal, or the TBoMS within the one or more full-duplex time periods or the one or more half-duplex time periods.

In aspect 38, the method of aspect 37 further includes that each of the one or more full-duplex time periods corresponds to at least one slot or one or more symbols within a slot.

In aspect 39, the method of aspect 37 or 38 further includes that the one or more full-duplex time periods include sub-band full-duplex resources for full-duplex operation of a base station and a half-duplex mode of the UE.

In aspect 40, the method of any of aspects 37-39 further includes that each resource allocation includes at least one of a FDRA and a TDRA for the at least one of the uplink channel, the downlink channel, the reference signal, or the TBoMS.

In aspect 41, the method of any of aspects 37-40 further includes that the at least one resource allocation is for one or more of: a first PDCCH without repetition across SBFD time periods and non-SBFD time periods, a second PDCCH with the repetition across the SBFD time periods and the non-SBFD time periods, a first PDSCH without the repetition across the SBFD time periods and the non-SBFD time periods, a second PDSCH with the repetition across the SBFD time periods and the non-SBFD time periods, a first PUSCH without the repetition across the SBFD time periods and the non-SBFD time periods, a second PUSCH with the repetition across the SBFD time periods and the non-SBFD time periods, a first PUCCH without the repetition across the SBFD time periods and the non-SBFD time periods, a second PUCCH with the repetition across the SBFD time periods and the non-SBFD time periods, a SRS in the SBFD time periods and the non-SBFD time periods, a CSI-RS the SBFD time periods and the non-SBFD time periods, TBoMS that include the SBFD time periods and the non-SBFD time periods, multiple PUSCHs scheduled by a single DCI across the SBFD time periods and the non-SBFD time periods, or multiple PDSCHs scheduled by the single DCI across the SBFD time periods and the non-SBFD time periods.

In aspect 42, the method of any of aspects 37-41 further includes that an adjustment for the at least conflicting resources is based on a defined rule.

In aspect 43, the method of any of aspects 37-42 further includes that the communication is rate matched in a full-duplex time period to avoid at least the conflicting resources in at least the full-duplex time period.

In aspect 44, the method of aspect 43 further includes that the communication is rate matched in the full-duplex time period and the half-duplex time period to avoid at least the conflicting resources in at least the full-duplex time period or at least the half-duplex time period.

In aspect 45, the method of aspect 44 further includes that the conflicting resource correspond to an uplink sub-band of a SBFD slot or symbol that conflicts with transmission of a PDCCH, a PDSCH, or a CSI-RS.

In aspect 46, the method of aspect 44 further includes that the conflicting resource correspond to an downlink sub-band of a SBFD slot or symbol that conflicts with reception of a PUCCH, a PUSCH, or a SRS.

In aspect 47, the method of any of aspects 43-46 further includes that the communication is rate matched around at least one of: a time gap between the at least one full-duplex time period and the at least one half-duplex time period, or a guard band between a downlink subband and an uplink subband frequency resources in a SBFD slot or symbol.

In aspect 48, the method of any of aspects 43-47 further includes that the communication is rate matched based on a rate match pattern for the downlink reception, an UCLI for the uplink transmission, or an uplink rate match pattern for the uplink transmission.

In aspect 49, the method of any of aspects 37-42 further includes that the communication is transmitted or received over conflicting full-duplex resources based on at least one of: a resource allocation for a downlink signal in a downlink symbol occurs in a SBFD time period, or the resource allocation is for an uplink signal in a flexible symbol that occurs in the SBFD time period.

In aspect 50, the method of aspect 49 further includes providing a configuration to disregard the conflicting full-duplex resources, wherein the communication is transmitted or received over the conflicting full-duplex resources based on the configuration.

In aspect 51, the method of any of aspects 37-42 further includes dropping a transmission or reception occasion that includes conflicting full-duplex resources in a full-duplex time period or includes conflicting half-duplex resources in a half-duplex time period.

In aspect 52, the method of any of aspects 37-51 further includes that each resource allocation comprises at least one of a TDRA or a FDRA.

In aspect 53, the method of aspect 52 further includes that the at least one resource allocation includes a first type of resource allocation associated with the one or more full-duplex time periods and a second type of resource allocation associated with the one or more half-duplex time periods, wherein the communication is based on a resource allocation type based on a time period type.

In aspect 54, the method of aspect 53 further includes that a cycle duration for the at least one resource allocation is longer than a number of symbols of the first type of resource allocation and the second type of resource allocation.

In aspect 55, the method of aspect 53 or 54 further includes that a cycle duration is counted from a starting symbol per occasion or a center symbol per occasion for both the first type of resource allocation and the second type of resource allocation.

In aspect 56, the method of any of aspects 53-55 further includes that the first type of resource allocation is applied to a full-duplex symbol, and the second type of resource allocation is applied to a half-duplex symbol.

In aspect 57, the method of any of aspects 53-56 further includes that the first type of resource allocation is applied across a first resource allocation if at least one symbol of the first resource allocation overlaps with a full-duplex time slot or a full-duplex symbol.

In aspect 58, the method of any of aspects 53-56 further includes that the first type of resource allocation or the second type of resource allocation is prioritized and applied across both full-duplex time periods and half-duplex time periods.

In aspect 59, the method of aspect 58 further includes that the communication is rate matched around conflicting resources.

In aspect 60, the method of any of aspects 53-59 further includes that the first type of resource allocation includes a first frequency hopping pattern associated with the one or more full-duplex time periods and the second type of resource allocation further include a second frequency hopping pattern associated with the one or more half-duplex time periods.

In aspect 61, the method of aspect 60 further includes that the communication includes the first frequency hopping pattern or the second frequency hopping pattern based on the time period type.

In aspect 62, the method of aspect 60 or 61 further includes that the first frequency hopping pattern includes a different frequency hopping offset than the second frequency hopping pattern.

In aspect 63, the method of any of aspects 60-62 further includes that the first type of resource allocation includes a same frequency domain resource allocation as the second type of resource allocation and a different frequency hopping pattern than the second type of resource allocation.

In aspect 64, the method of aspect 63 further includes that the second type of resource allocation includes a first offset for frequency hopping and the first type of resource allocation includes two offsets for the frequency hopping.

In aspect 65, the method of any of aspects 37-42 further includes that skipping scheduling a channel type or a reference signal with a resource allocation that overlaps with a full-duplex resource of a different direction.

Aspect 66 is an apparatus for wireless communication at a network node, the apparatus including memory, and at least one processor coupled to the memory and, based at least in part on information stored in the memory, the at least one processor is configured to perform the method of any of aspects 37-65.

Aspect 67 is an apparatus for wireless communication at a network node, the apparatus including means for performing the method of any of aspects 37-65.

In aspect 68, the apparatus of aspect 66 or 67 further includes at least one transceiver.

Aspect 69 is a computer-readable medium, e.g., non-transitory computer-readable medium, storing computer executable code at a network node, the code when executed by at least one processor causes the network node to perform the method of any of aspects 37-65.

What is claimed is:

1. An apparatus for wireless communication at a UE, comprising:
at least one memory; and
at least one processor coupled to the at least one memory and, based at least in part on information stored in the at least one memory, the at least one processor, individually or in any combination, is configured to cause the UE to:
receive an indication of one or more full-duplex time periods and one or more half-duplex time periods;
receive at least one resource allocation for downlink reception or uplink transmission of at least one of an uplink channel, a downlink channel, a reference signal, or a transport block over multiple slots (TBoMS), the at least one resource allocation that includes resources across at least one full-duplex time period and at least one half-duplex time period;
adjust processing for at least conflicting resources of the at least one resource allocation based on the at least one resource allocation for the at least one of the uplink channel, the downlink channel, the reference signal, or the TBoMS within the one or more full-duplex time periods or the one or more half-duplex time periods; and
transmit or receive communication after adjustment of the processing for at least the conflicting resources.

2. The apparatus of claim 1, wherein each of the one or more full-duplex time periods corresponds to at least one slot or one or more symbols within a slot, wherein the one or more full-duplex time periods include sub-band full-duplex resources for full-duplex operation of a base station, and the UE operates in a half-duplex mode.

3. The apparatus of claim 1, wherein each resource allocation includes at least one of a frequency domain resource allocation (FDRA) and a time domain resource allocation (TDRA) for the at least one of the uplink channel, the downlink channel, the reference signal, or the TBoMS.

4. The apparatus of claim 1, wherein the at least one processor is, individually or in any combination, configured to cause the UE to adjust the processing based on the at least one resource allocation being for one or more of:
a first physical downlink control channel (PDCCH) without repetition across sub-band full duplex (SBFD) time periods and non-SBFD time periods,
a second PDCCH with the repetition across the SBFD time periods and the non-SBFD time periods,
a first physical downlink shared channel (PDSCH) without the repetition across the SBFD time periods and the non-SBFD time periods,
a second PDSCH with the repetition across the SBFD time periods and the non-SBFD time periods,
a first physical uplink shared channel (PUSCH) without the repetition across the SBFD time periods and the non-SBFD time periods,
a second PUSCH with the repetition across the SBFD time periods and the non-SBFD time periods,
a first physical uplink control channel (PUCCH) without the repetition across the SBFD time periods and the non-SBFD time periods,
a second PUCCH with the repetition across the SBFD time periods and the non-SBFD time periods,
a sounding reference signal (SRS) in the SBFD time periods and the non-SBFD time periods,
a channel state information reference signal (CSI-RS) the SBFD time periods and the non-SBFD time periods,
the TBoMS that include the SBFD time periods and the non-SBFD time periods, multiple PUSCHs scheduled by a single downlink control information (DCI) across the SBFD time periods and the non-SBFD time periods, or
multiple PDSCHs scheduled by the single DCI across the SBFD time periods and the non-SBFD time periods.

5. The apparatus of claim 1, wherein to adjust the processing, the at least one processor is, individually or in any combination, configured to cause the UE:
rate match the communication in the one or more half-duplex time periods and the one or more full-duplex time periods to avoid one or more conflicting resource blocks in a full-duplex time period.

6. The apparatus of claim 5, wherein the at least one processor is, individually or in any combination, configured to cause the UE to rate match for multiple transmission or reception occasions, including one or more occasions that do not include the one or more conflicting resource blocks.

7. The apparatus of claim 1, wherein the at least one processor is, individually or in any combination, configured to cause the UE to rate match the communication in a full-duplex time period or a half-duplex time period to avoid at least the conflicting resources in at least the full-duplex time period or at least the half-duplex time period and around at least one of:
a time gap between the at least one full-duplex time period and the at least one half-duplex time period, or
a guard band between a downlink sub-band and an uplink sub-band frequency resources in a sub-band full-duplex (SBFD) slot or symbol.

8. The apparatus of claim 1, wherein the at least one processor is, individually or in any combination, configured to cause the UE to rate match the communication in a full-duplex time period or a half-duplex time period to avoid at least the conflicting resources in at least the full-duplex time period or at least the half-duplex time period, based on a rate match pattern for the downlink reception, an uplink cancellation indication (UCLI) for the uplink transmission, or an uplink rate match pattern for the uplink transmission.

9. The apparatus of claim 1, wherein to adjust the processing the at least one processor is, individually or in any combination, configured to cause the UE to transmit or receive the communication over conflicting full-duplex resources based on at least one of:
transmit or receive a downlink signal over the conflicting full-duplex resources based on a first condition that a downlink signal resource allocation for the downlink signal is in a downlink symbol or a flexible symbol that occurs in a sub-band full-duplex (SBFD) time period, or
transmit or receive an uplink signal over the conflicting full-duplex resources based on a second condition that an uplink signal resource allocation for the uplink signal is in the flexible symbol that occurs in the SBFD time period and occasion common adaptation is applied across multiple transmission occasions.

10. The apparatus of claim 9, wherein the at least one processor is, individually or in any combination, further configured to cause the UE to:
receive a configuration to disregard the conflicting full-duplex resources; and
transmit or receive the communication over the conflicting full-duplex resources based on the configuration.

11. The apparatus of claim 1, wherein each resource allocation comprises at least one of a time domain resource allocation (TDRA) or a frequency domain resource allocation (FDRA) and, wherein the at least one resource allocation includes a first type of resource allocation associated with the one or more full-duplex time periods and a second type of resource allocation associated with the one or more half-duplex time periods, wherein to adjust the processing, the at least one processor is, individually or in any combination, configured to cause the UE to apply a resource allocation type based on a time period type.

12. The apparatus of claim 11, wherein a cycle duration for the at least one resource allocation is longer than a number of symbols of the first type of resource allocation and the second type of resource allocation.

13. The apparatus of claim 11, wherein a cycle duration is counted from a starting symbol per occasion or a center symbol per occasion for both the first type of resource allocation and the second type of resource allocation.

14. The apparatus of claim 11, wherein the first type of resource allocation is for application across a first resource allocation if at least one symbol of the first resource allocation overlaps with a full-duplex time slot or a full-duplex symbol.

15. The apparatus of claim 11, wherein the at least one processor is, individually or in any combination, further configured to cause the UE to:
apply the first type of resource allocation or the second type of resource allocation having a higher priority across both full-duplex time periods and half-duplex time periods.

16. The apparatus of claim 15, wherein the at least one processor is, individually or in any combination, further configured to cause the UE to:
rate match the communication around conflicting resources.

17. The apparatus of claim 11, wherein the first type of resource allocation includes a first frequency hopping pattern associated with the one or more full-duplex time periods and the second type of resource allocation further include a second frequency hopping pattern associated with the one or more half-duplex time periods.

18. The apparatus of claim 17, wherein to adjust the processing, the at least one processor is, individually or in any combination, configured to cause the UE to:
apply the first frequency hopping pattern or the second frequency hopping pattern based on the time period type.

19. The apparatus of claim 18, wherein the first frequency hopping pattern includes a different frequency hopping offset than the second frequency hopping pattern.

20. The apparatus of claim 18, wherein the first type of resource allocation includes a same frequency domain resource allocation as the second type of resource allocation and a different frequency hopping pattern than the second type of resource allocation.

21. The apparatus of claim 20, wherein the second type of resource allocation includes a first offset for frequency hopping and the first type of resource allocation includes two offsets for the frequency hopping.

22. A method of wireless communication at a UE, comprising:
receiving an indication of one or more full-duplex time periods and one or more half-duplex time periods;
receiving at least one resource allocation for downlink reception or uplink transmission of at least one of an uplink channel, a downlink channel, a reference signal, or a transport block over multiple slots (TBoMS), the at least one resource allocation that includes resources across at least one full-duplex time period and at least one half-duplex time period;
adjusting processing for at least conflicting resources of the at least one resource allocation based on the at least one resource allocation for the at least one of the uplink channel, the downlink channel, the reference signal, or the TBoMS within the one or more full-duplex time periods or the one or more half-duplex time periods; and
transmitting or receiving communication after adjusting the processing for at least the conflicting resources.

23. The method of claim 22, wherein each resource allocation includes at least one of a frequency domain resource allocation (FDRA) and a time domain resource allocation (TDRA) for the at least one of the uplink channel, the downlink channel, the reference signal, or the TBoMS, and wherein adjusting the processing is based on the at least one resource allocation being for one or more of:
a first physical downlink control channel (PDCCH) without repetition across sub-band full duplex (SBFD) time periods and non-SBFD time periods,
a second PDCCH with the repetition across the SBFD time periods and the non-SBFD time periods,
a first physical downlink shared channel (PDSCH) without the repetition across the SBFD time periods and the non-SBFD time periods,
a second PDSCH with the repetition across the SBFD time periods and the non-SBFD time periods,
a first physical uplink shared channel (PUSCH) without the repetition across the SBFD time periods and the non-SBFD time periods,
a second PUSCH with the repetition across the SBFD time periods and the non-SBFD time periods,
a first physical uplink control channel (PUCCH) without the repetition across the SBFD time periods and the non-SBFD time periods,
a second PUCCH with the repetition across the SBFD time periods and the non-SBFD time periods,
a sounding reference signal (SRS) in the SBFD time periods and the non-SBFD time periods,
a channel state information reference signal (CSI-RS) the SBFD time periods and the non-SBFD time periods,
the TBoMS that include the SBFD time periods and the non-SBFD time periods, multiple PUSCHs scheduled by a single downlink control information (DCI) across the SBFD time periods and the non-SBFD time periods, or
multiple PDSCHs scheduled by the single DCI across the SBFD time periods and the non-SBFD time periods.

24. The method of claim 22, wherein adjusting the processing, further includes:
rate matching the communication in the one or more half-duplex time periods and the one or more full-duplex time periods to avoid one or more conflicting resource blocks in a full-duplex time period, wherein the rate matching is performed for multiple transmission or reception occasions, including one or more occasions that do not include the one or more conflicting resource blocks.

25. The method of claim 22, wherein each resource allocation comprises at least one of a time domain resource allocation (TDRA) or a frequency domain resource allocation (FDRA) and, wherein the at least one resource allocation includes a first type of resource allocation associated with the one or more full-duplex time periods and a second type of resource allocation associated with the one or more half-duplex time periods, wherein to adjusting the processing includes applying a resource allocation type based on a time period type.

26. The method of claim 25, wherein one of:
a first cycle duration for the at least one resource allocation is longer than a number of symbols of the first type of resource allocation and the second type of resource allocation,
a second cycle duration is counted from a starting symbol per occasion or a center symbol per occasion for both the first type of resource allocation and the second type of resource allocation,
the first type of resource allocation includes a first frequency hopping pattern associated with the one or more full-duplex time periods and the second type of resource allocation further include a second frequency hopping pattern associated with the one or more half-duplex time periods,
the first frequency hopping pattern includes a different frequency hopping offset than the second frequency hopping pattern,
the first type of resource allocation includes a same frequency domain resource allocation as the second type of resource allocation and a different frequency hopping pattern than the second type of resource allocation, or
the second type of resource allocation includes a first offset for frequency hopping and the first type of resource allocation includes two offsets for the frequency hopping.

27. A method of wireless communication at a network node, comprising:
providing an indication of one or more full-duplex time periods and one or more half-duplex time periods;
providing at least one resource allocation for a user equipment (UE) for downlink reception or uplink transmission of at least one of an uplink channel, a downlink channel, a reference signal, or a transport block over multiple slots (TBoMS), the at least one resource allocation that includes resources across at least one full-duplex time period and at least one half-duplex time period; and
transmitting or receiving communication adjusted for at least conflicting resources of the at least one resource allocation based on the at least one resource allocation for the at least one of the uplink channel, the downlink channel, the reference signal, or the TBoMS within the one or more full-duplex time periods or the one or more half-duplex time periods.

28. An apparatus for wireless communication at a network node, comprising:
at least one memory; and
at least one processor coupled to the at least one memory and, based at least in part on information stored in the memory, the at least one processor is, individually or in any combination, configured to cause the network node to:
provide an indication of one or more full-duplex time periods and one or more half-duplex time periods;
provide at least one resource allocation for a user equipment (UE) for downlink reception or uplink transmission of at least one of an uplink channel, a downlink channel, a reference signal, or a transport block over multiple slots (TBoMS), the at least one resource allocation that includes resources across at least one full-duplex time period and at least one half-duplex time period; and
transmit or receive communication adjusted for at least conflicting resources of the at least one resource allocation based on the at least one resource allocation for the at least one of the uplink channel, the downlink channel, the reference signal, or the TBoMS within the one or more full-duplex time periods or the one or more half-duplex time periods.

29. The apparatus of claim 28, wherein the communication is rate matched in the one or more half-duplex time periods and the one or more full-duplex time periods to avoid one or more conflicting resource blocks in a full-duplex time period, wherein the communication is rate matched for multiple transmission or reception occasions, including one or more occasions that do not include the one or more conflicting resource blocks.

30. The apparatus of claim 28, wherein each resource allocation comprises at least one of a time domain resource allocation (TDRA) or a frequency domain resource allocation (FDRA) and, wherein the at least one resource allocation includes a first type of resource allocation associated with the one or more full-duplex time periods and a second type of resource allocation associated with the one or more half-duplex time periods, wherein one of:
a first cycle duration for the at least one resource allocation is longer than a number of symbols of the first type of resource allocation and the second type of resource allocation,
a second cycle duration is counted from a starting symbol per occasion or a center symbol per occasion for both the first type of resource allocation and the second type of resource allocation,
the first type of resource allocation includes a first frequency hopping pattern associated with the one or more full-duplex time periods and the second type of resource allocation further include a second frequency hopping pattern associated with the one or more half-duplex time periods,
the first frequency hopping pattern includes a different frequency hopping offset than the second frequency hopping pattern,
the first type of resource allocation includes a same frequency domain resource allocation as the second type of resource allocation and a different frequency hopping pattern than the second type of resource allocation, or
the second type of resource allocation includes a first offset for frequency hopping and the first type of resource allocation includes two offsets for the frequency hopping.
